(19) United States
(12) Patent Application Publication
(10) Pub. No.: US 2016/0217216 A1
(43) Pub. Date: Jul. 28, 2016

(54) SYSTEMS, METHODS, AND DEVICES FOR IMPLEMENTING A REFERRAL SEARCH

(71) Applicant: The One Page Company Inc., San Francisco, CA (US)

(72) Inventors: Justin Baird, Lilyfield (AU); Joanna Riley, San Francisco, CA (US); Jeff Mills, Half Moon Bay, CA (US); Jeremy Malander, Half Moon Bay, CA (US); Peter Hatch, Berkeley, CA (US)

(73) Assignee: The One Page Company Inc., San Francisco, CA (US)

(21) Appl. No.: 15/007,111

(22) Filed: Jan. 26, 2016

Related U.S. Application Data
(60) Provisional application No. 62/108,379, filed on Jan. 27, 2015.
(60) Provisional application No. 62/108,382, filed on Jan. 27, 2015.

(51) Int. Cl. G06F 17/30

(52) U.S. Cl. CPC G06F 17/30876; G06F 17/30336; G06F 17/30864

(57) ABSTRACT

Systems, methods, and devices are disclosed herein for implementing a referral search. Methods may include retrieving candidate profile data and social connection data from at least one data source, where the candidate profile data characterizes one or more features associated with a plurality of candidates, and where the social connection data characterizes social connections between the plurality of candidates and a plurality of other entities. The methods may also include generating a first plurality of candidate profile data objects based on the retrieved candidate profile data and social connection data, where each of the first plurality of candidate profile data objects is associated with at least one candidate. The methods may further include generating an index data object based on the first plurality of candidate profile data objects.

### CROSS-REFERENCE TO RELATED APPLICATIONS

This application claims the benefit under 35 U.S.C. §119(e) of U.S. Provisional Patent Application No. 62/108,379, filed on Jan. 27, 2015, and U.S. Provisional Patent Application No. 62/108,382, filed on Jan. 27, 2015, which are both incorporated by reference herein in their entirety for all purposes.

### TECHNICAL FIELD

The present disclosure relates to the field of automation of referrals associated with companies.

### DESCRIPTION OF RELATED ART

An employee referral may be an internal recruitment method employed by organizations to identify potential candidates from their existing employee's relationships. An employee referral scheme encourages a company's existing employees to select and recruit suitable candidates. As a reward, the employer typically pays the referring employee a referral bonus. Recruiting candidates using employee referral may be a cost effective and efficient recruitment method to recruit candidates and as such, employers of all sizes, across all industries are trying to increase the volume of recruits through this channel. Conventional referral techniques remain limited because individual recruiters and employees have to handle tasks associated with the recruitment manually. Accordingly, conventional referral schemes in large contexts, such as companies and organizations, remain impractical due to the burden placed on recruiters and employees.

### SUMMARY

Systems, methods, and devices are disclosed herein for implementing a referral search. Methods may include retrieving candidate profile data and social connection data from at least one data source, where the candidate profile data characterizes one or more features associated with a plurality of candidates, and where the social connection data characterizes social connections between the plurality of candidates and a plurality of other entities. The methods may also include generating a first plurality of candidate profile data objects based on the retrieved candidate profile data and social connection data, where each of the first plurality of candidate profile data objects is associated with at least one candidate. The methods may further include generating an index data object based on the first plurality of candidate profile data objects.

In various embodiments, the candidate profile data characterizes professional experience and biographical data associated with the plurality of candidates. In some embodiments, the retrieved data is aggregated from a plurality of heterogeneous data sources comprising a plurality of social networking sites and at least one employee database. In various embodiments, the generating of the plurality of candidate profile data objects includes merging at least some of the data retrieved from the plurality of heterogeneous data sources into the first plurality of candidate profile data objects. In various embodiments, the generating of the plurality of candidate profile data objects also includes mapping at least some of the data retrieved from the plurality of heterogeneous data sources to a plurality of previously stored candidate profile data objects. In some embodiments, the methods may further include receiving a plurality of search parameters associated with an employment opportunity.

The methods may also include querying the index data object based on the plurality of search parameters to identify a second plurality of candidate profile data objects, and generating a result object based on the identified second plurality of candidate profile data objects. In various embodiments, the result represents the second plurality of candidates sorted based on their associated connectivity metrics. In some embodiments, the result enables the generation of one or more automatic messages specific to at least one candidate associated with the second plurality of candidate profile data objects. The methods may also include automatically updating a data storage system based on one or more data values associated with the one or more automatic messages.

Also disclosed herein are systems that may include a profile data aggregator configured to retrieve candidate profile data and social connection data from at least one data source, where the candidate profile data characterizes one or more features associated with a plurality of candidates, and where the social connection data characterizes social connections between the plurality of candidates and a plurality of other entities. The profile data aggregator may also be configured to include generate a first plurality of candidate profile data objects based on the retrieved candidate profile data and social connection data, each of the first plurality of candidate profile data objects being associated with at least one candidate. The profile data aggregator may also be configured to generate an index data object based on the first plurality of candidate profile data objects. The systems may also include a connectivity metric generator configured to generate a plurality of connectivity metrics based, at least in part, on the first plurality of candidate profile data objects. The systems may further include a referral processing engine configured to return at least one candidate and at least one employee as a result of a search executed on the index data object.

In some embodiments, the retrieved data is aggregated from a plurality of heterogeneous data sources comprising a plurality of social networking sites and at least one employee database. In various embodiments, the profile data aggregator is further configured to merge at least some of the data retrieved from the plurality of heterogeneous data sources into the first plurality of candidate profile data objects. In some embodiments, the generating of the first plurality of candidate profile data objects comprises mapping at least some of the data retrieved from the plurality of heterogeneous data sources to a plurality of previously stored candidate profile data objects. In various embodiments, the referral processing engine is further configured to query the index data object based on a plurality of search parameters to identify a second plurality of candidate profile data objects. The referral processing engine may also be configured to generate a result object based on the identified second plurality of candidate profile data objects. In some embodiments, the referral processing engine is further configured to generate one or more messages based, at least in part, on the plurality of connectivity metrics, the one or more messages being configured to automate a referral of at least one candidate.

Also disclosed herein are devices that may include first processing node configured to retrieve candidate profile data and social connection data from at least one data source, where the candidate profile data characterizes one or more features associated with a plurality of candidates, and where the social connection data characterizes social connections between the plurality of candidates and a plurality of other entities. The first processing node may also be configured to generate a first plurality of candidate profile data objects based on the retrieved candidate profile data and social connection data, where each of the first plurality of candidate profile data objects is associated with at least one candidate. The first processing node may also be configured to generate an index data object based on the first plurality of candidate profile data objects. The devices may further include a second processing node configured to generate a plurality of connectivity metrics based, at least in part, on the first plurality of candidate profile data objects. The devices may also include a third processing node configured to return at least one candidate and at least one employee as a result of a search executed on the index data object.

In various embodiments, the retrieved data is aggregated from a plurality of heterogeneous data sources comprising a plurality of social networking sites and at least one employee database. In some embodiments, the first processing node is further configured to merge at least some of the data retrieved from the plurality of heterogeneous data sources into the first plurality of candidate profile data objects. In various embodiments, the generating of the first plurality of candidate profile data objects includes mapping at least some of the data retrieved from the plurality of heterogeneous data sources to a plurality of previously stored candidate profile data objects. In various embodiments, the third processing node is further configured to query the index data object based on a plurality of search parameters to identify a second plurality of candidate profile data objects. In some embodiments, the third processing node is further configured to generate a result object based on the identified second plurality of candidate profile data objects. In various embodiments, the third processing node is further configured to generate one or more messages based, at least in part, on the plurality of connectivity metrics, where the one or more messages are configured to automate a referral of at least one candidate.

### BRIEF DESCRIPTION OF THE DRAWINGS

The disclosure may best be understood by reference to the following description taken in conjunction with the accompanying drawings, which illustrate particular embodiments.

FIG. 1 illustrates a diagram of an example of a referral system, implemented in accordance with some embodiments.

FIG. 2 illustrates a flow chart of an example of a method for facilitating the referral of a candidate, implemented in accordance with some embodiments.

FIG. 3 illustrates a flow chart of an example of a method for generating candidate profile data, implemented in accordance with some embodiments.

FIG. 4 illustrates a flow chart of an example of a method for querying candidate profile data, implemented in accordance with some embodiments.

FIG. 5 illustrates a flow chart of an example of a method for generating a connectivity metric, implemented in accordance with some embodiments.

FIG. 6 illustrates a flow chart of an example of a method for implementing communications associated with the referral of a candidate in accordance with some embodiments.

FIG. 7 illustrates a graphical representation of a user interface screen configured to receive one or more search parameters.

FIG. 8 illustrates a graphical representation of a user interface screen configured to display the results returned by a search, implemented in accordance with some embodiments.

FIG. 9 illustrates a graphical representation of a user interface screen configured to receive a selection of an employee, implemented in accordance with some embodiments.

FIG. 10 illustrates a graphical representation of a user interface screen configured to receive a selection of a plurality of employees, implemented in accordance with some embodiments.

FIG. 11 illustrates a graphical representation of a user interface screen configured to provide a first message to an employee, implemented in accordance with some embodiments.

FIG. 12 illustrates a graphical representation of a user interface screen configured to provide a second message to an employee, implemented in accordance with some embodiments.

FIG. 13 illustrates a graphical representation of a user interface screen configured to provide a third message to an employee, implemented in accordance with some embodiments.

FIG. 14 illustrates a graphical representation of a user interface screen configured to provide a fourth message to a company, implemented in accordance with some embodiments.

FIG. 15 illustrates a graphical representation of a user interface screen configured to display referral data associated with a referral method, implemented in accordance with some embodiments.

FIG. 16 illustrates a graphical representation of several social connections, implemented in accordance with some embodiments.

FIG. 17 illustrates a graphical representation of several social connections that may be associated with a company, implemented in accordance with some embodiments.

FIG. 18 illustrates a graphical representation of various data sources that may be used to enrich candidate profile data, implemented in accordance with some embodiments.

FIG. 19 illustrates a data processing system configured in accordance with some embodiments.

### DESCRIPTION OF EXAMPLE EMBODIMENTS

Reference will now be made in detail to some specific examples of the embodiments disclosed herein including the best modes contemplated by the inventors for carrying out the embodiments disclosed herein. Examples of these specific embodiments are illustrated in the accompanying drawings. While embodiments are disclosed herein, it will be understood that they are not intended to limit the disclosure to the described embodiments. On the contrary, it is intended to cover alternatives, modifications, and equivalents as may be included within the spirit and scope of the embodiments disclosed herein as defined by the appended claims.

As similarly discussed above, an employee referral may be an internal recruitment method employed by organizations to identify potential candidates from their existing employee's relationships. An employee referral scheme encourages a company's existing employees to select and recruit suitable candidates. In various embodiments, recruiting candidates using employee referral may be an effective and efficient recruitment method to recruit candidates and as such, employers of all sizes, across all industries may try to increase the volume of recruits through this channel. As per the Global Employee Referral Index 2013 Survey, 92% of the participants reported employee referrals as one of the top recruiting sources for recruiting. Employee referral schemes may provide the benefits of improved candidate quality, ‘fit’, and retention levels, while at the same time delivering a significant reduction in recruitment expenditure.

However, while there are many benefits, only 7% of new employees are hired via referrals. Such limitations of conventional referrals are largely due to the lack of automation in the referral process, a lack of access to potential candidates, and the amount of manual effort and time it takes for employees to manually assist in the process. Conventional techniques have been focused on manual identification of potential candidates, the manual collection of documents, as well as manual review of such documents. Due to the large amount of effort required, such manual techniques remain limited in their ability to identify potential candidates and facilitate communications with such potential candidates. Accordingly, in conventional techniques, the onus is still on each individual employee to make conventional systems work.

Various referral systems are disclosed herein to automate the processes of searching and sourcing potential candidates for employee referral, as well as automate the interactions between such candidates and various other entities, such as employees and recruiters. Accordingly, systems, devices, and methods as disclosed herein may generate candidate profile data that includes profiles of an expansive collection of potential candidates. Such candidate profile data may include far more potential candidates than a particular employee might be aware of, and may form the basis of identifying connections between employees and candidates that they might not even be aware of. Moreover, systems, methods, and devices as disclosed herein may automate the process of identifying employees for a referral process, automate the interactions between employees and candidates, as well as automate the updating and maintenance of candidate profile data bases on such interactions. Accordingly, systems and devices as disclosed herein may implement novel functionalities that configure and enable systems and devices that may include client machines as disclosed herein to identify, generate, and maintain candidate profile data associated with expansive populations of potential candidates, and facilitate automated referral processes associated with such potential candidates on a large scale that may not otherwise be possible by conventional manual techniques.

Some of the techniques of the embodiments disclosed herein will be described in the context of referrals, such as referrals for positions or jobs at companies. However, it should be noted that the techniques of the embodiments disclosed herein apply to a wide variety of different contexts as may be present in any suitable organization or entity. The same or similar techniques could be used to not only find potential employment candidates, but to find other people connected to existing employees with specific experience or knowledge, e.g. sales prospects. In various embodiments, an entity, such as a person could perform similar searches of the employee's connection information to locate a contact within another company that could be a good candidate for the company's products and/or services.

In the following description, numerous specific details are set forth order to provide a thorough understanding of the embodiments disclosed herein. Particular example embodiments may be implemented without some or all of these specific details. In other instances, well known process operations have not been described in detail in order not to unnecessarily obscure the present disclosure.

Various techniques and mechanisms of the embodiments disclosed herein will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the embodiments disclosed herein unless otherwise noted.

### OVERVIEW

Methods, systems, and devices are disclosed herein for facilitating the processing of referrals for a company or organization. As disclosed herein, a company may be an example company using an automated referral system as disclosed herein, such as a referral system provided by The One Page Company Inc. Moreover, an employee may be a current employee of a company. Furthermore, a candidate may be a person outside of the company who has been identified as a prospective future employee of the company. Further still, a recruiter may be an employee of the company that is tasked with finding a new employee. As will be discussed in greater detail below, a connectivity metric, such as a company connection strength, may identify or characterize how strongly connected a candidate may be to the company based on an analysis of one or more connections between the candidate and the company as well as its employees.

Referral systems as disclosed herein may enable a recruiter at a company to identify candidates through existing employee social connections. According to some embodiments, the referral system may be an automated system that enriches available data underlying the referral process and automates one or more portions or substantially all of the referral process. In this way, referral systems as disclosed herein may efficiently and effectively identify candidates for a position, and automate a referral process associated with the identified candidates.

In various embodiments, referral systems as disclosed herein may facilitate and automate the process of implementing a referral that may be made by an employee. In some embodiments, referral systems as disclosed herein may query various different heterogeneous data sources to aggregate candidate profile data from numerous different sources which may include social networking services, search engines, and employee databases. Such data may also include a potential candidate's professional experience and other online contributions to publicly available websites, products, and systems. Thus, referral systems as disclosed herein may store and maintain profile data for numerous potential candidates for a job, the number of candidates identified by the referral systems may be far greater than the candidates the employee, or the organization that employs the employee, is aware. Thus, referral systems disclosed herein may accumulate and utilize a database of potential candidates for a position that may include or represent a population of candidates far greater and more comprehensive than what is known to the employee and organization.

In some embodiments, referral systems as disclosed herein may facilitate the automation of identification of potential candidates for an employment opportunity. For example, an entity, such as a recruiter, may enter parameters, such as keywords, associated with the employment opportunity that may be descriptive of the employment opportunity and may identify desired skills associated with the employment opportunity. The referral system may query the database of candidates and identify potential candidates based on the result of the query. In this way, the extensive database of potential candidates may be queried and several candidates for the employment opportunity may be identified.

In addition to identifying potential candidates for the employment opportunity, referral systems as disclosed herein may identity connections between the potential candidates and on or more other entities, such as various employees of the organization associated with the various embodiments. Thus, referral systems as disclosed herein may analyze the employees of the organization and the identified potential candidates, and the referral systems disclosed herein may identify any existing connections between each combination of employee and potential candidate. As will be discussed in greater detail below, such connections may be identified based on the aggregated data, and may represent social connections such as friendship or business acquaintanceship.

In some embodiments, referral systems disclosed herein may be configured to analyze the identified connections and generate connectivity metrics based on the identified connections. The connectivity metrics may characterize a strength of each identified connection between the employees and potential candidates for the employment opportunity. In this way, referral systems disclosed herein may identify and assess a strength of all identifiable connections between employees of an organization and potential candidates for an employment opportunity within that organization. As will be discussed in greater detail below, the results of the analysis may be returned to the recruiter and may be sorted, ranked, arranged, and configured to present the results to the recruiter in a manner that may be configured by the recruiter or based on a designated or default manner. Furthermore, as will be discussed in greater detail below, the results may be graphed and presented to the recruiter as part of a visual representation.

Furthermore, referral systems disclosed herein may automate the process of implementing the referral. For example, once presented with the results, the recruiter may be provided with access to automated messaging capabilities that enable the recruiter to contact numerous employees about one or more potential candidates. Further still, features of the correspondence generated between the recruiter and employees may be automatically stored and maintained in a data storage system. In this way, referral systems as disclosed herein may automatically and dynamically update status information associated with potential candidates, thus ensuring that the implementation of the referral is based on the most recent and accurate information available.

### EXAMPLE EMBODIMENTS

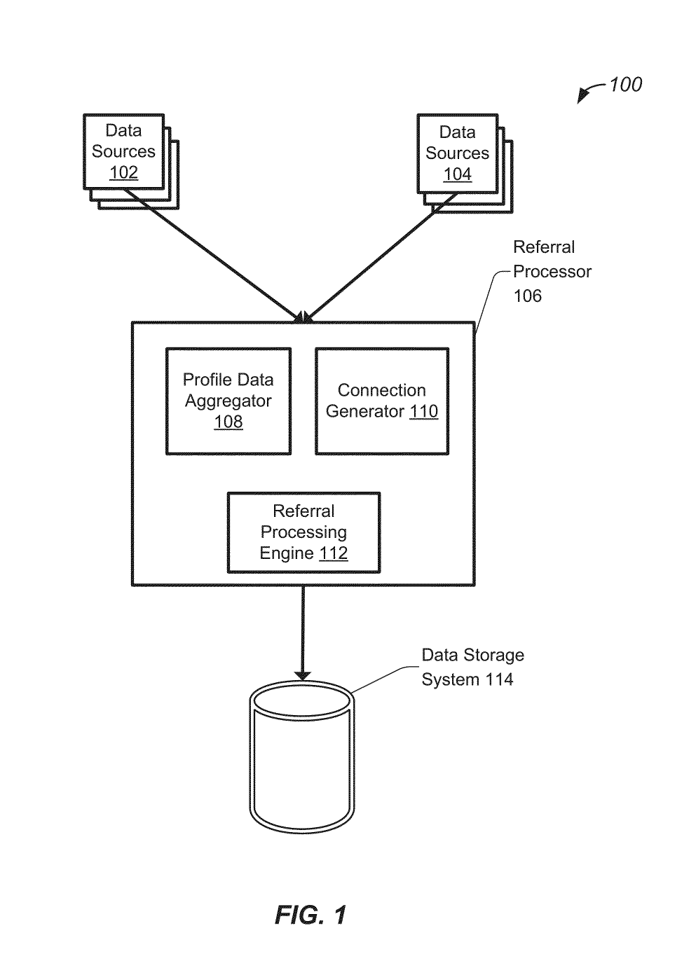

FIG. 1 illustrates a diagram of an example of a referral system, implemented in accordance with some embodiments. As similarly discussed above, a referral system, such as referral system 100, may be implemented to automatically identify various candidates who may be suitable for an open or available position at a company or organization. Referral system 100 may also be configured to identify connections between the candidates and the company as well as employees of the company. Referral system 100 may be further configured to automatically handle communications with employees and candidates to implement a referral process, and contact a potential candidate regarding the available position.

Accordingly, referral system 100 may include data sources, such as data sources 102 and data sources 104. In various embodiments, data sources 102 may include one or more portions of candidate data that may characterize one or more biographical, personal, and/or professional features of a candidate. For example, candidate data associated with a particular candidate may include one or more data values identifying the candidate's name, professional title, geographical location, and/or contact information. In one example, data sources 102 may include an identity verification system that stores personal information associated with several users and entities which may include potential candidates.

Referral system 100 may further include data sources 104 may include user profile data that may characterize various biographical, personal, and/or professional features of a candidate as well as various social connection data associated with the candidate. For example, the user profile data may include one or more data values that identify the candidate's social handle, a list of groups that the candidate belongs to, and a list of other users or entities that the candidate is connected to. In various embodiments, data sources 104 may include data stores storing data from one or more entities such as third party data aggregators, search engines, and social media networks. According to some embodiments, data sources 102 and data sources 104 may be implemented as one or more data storage systems, such as database systems or distributed file systems.

Referral system 100 may include referral processor 106 that may be configured to manage the implementation of one or more referral methods, as disclosed herein. For example, referral processor 106 may be configured to aggregate data associated with a candidate to generate candidate profiles, generate one or more connectivity metrics, and manage the generation and handling of messages between one or more entities, such as candidates and employees. According to some embodiments, referral processor 106 may include profile data aggregator 108 which may be configured to aggregate data from various different sources. Profile data aggregator 108 may be further configured to include the aggregated data as candidate profile data in one or more data objects configured to store candidate profiles. Accordingly, profile data aggregator 108 may be configured to query various different data sources, such as data sources 102 and data sources 104, and may be further configured to store the aggregated data as one or more data objects in a queryable data storage system, such as data storage system 114, discussed in greater detail below.

Referral processor 106 may further include connectivity metric generator 110 which may be configured to analyze one or more data values of the candidate profile data to identify connections or associations between candidates and various other entities, such as a company and/or employees of the company. Accordingly, connectivity metric generator 110 may be configured to analyze the candidate profile data and generate one or more connectivity metrics based on the analysis. The connectivity metrics may characterize or identify a strength of a connection between the candidate and the company as well as the employees of the company. In various embodiments, the connectivity metrics may also be stored in a data storage system, such as data storage system 114.

Referral processor 106 may also include referral processing engine 112 which may be configured to generate and handle communications between one or more entities, such as the candidates, employees, and company. Accordingly, referral processing engine 112 may be configured to generate text messages based on the candidate profile data and connectivity metrics, provide the messages to employees, and receive input from the employees. Referral processing engine 112 may be further configured to generate text messages based on the input received from the employees, provide the messages to candidates, and receive input from the candidates. Referral processing engine 112 may also be configure to update candidate profile data stored in a data storage system based on input received from candidates as well as employees. In some embodiments, referral processing engine 112 may be further configured to query various data to retrieve data underlying the messages. For example, referral processing engine may be configured to query an index data object generated by profile data aggregator 108 based various search parameters to identify various candidate profile data objects. Moreover, referral processing engine 112 may be further configured to generate result objects based on the identified candidate profile data objects.

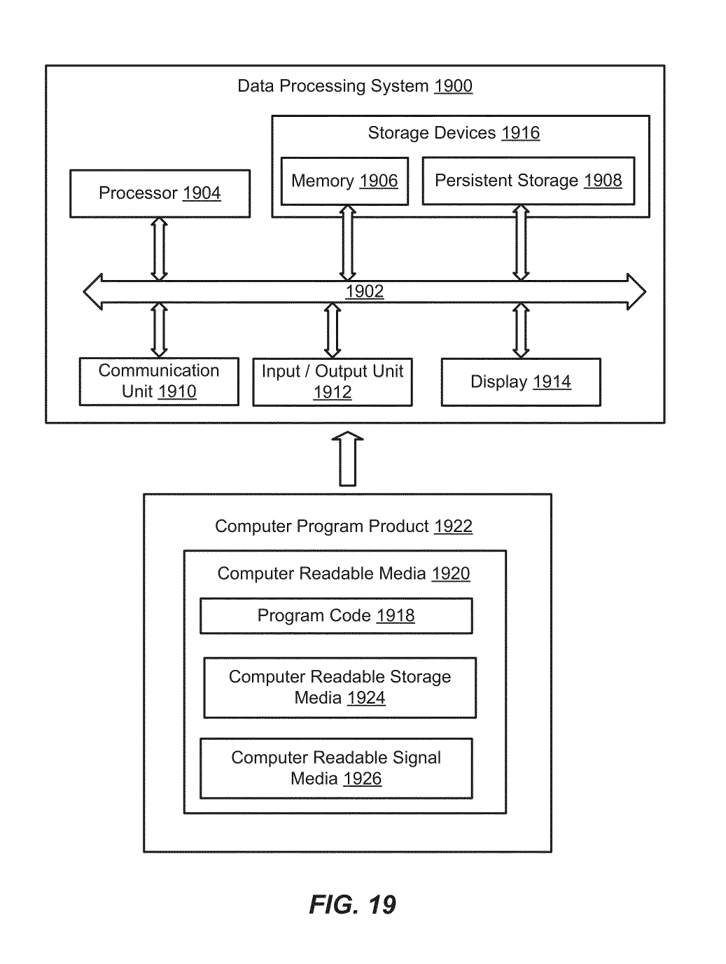

In various embodiments, referral processor 106 may be implemented in a data processing system, as discussed below with reference to FIG. 19. In some embodiments, referral processor 106 may be implemented using specific configurations of custom hardware that is configured to implement the novel embodiments disclosed herein. For example, referral processor 106 may be programmed into reprogrammable logic devices, or may be implemented in application specific hardware such as application specific integrated circuits (ASICs). Moreover, referral processor 106 may include one or more machine learning components configured to implement embodiments discussed in greater detail below. In this way, referral processor 106 may be specifically and particularly configured to implement the embodiments disclosed herein, and implement the new functionalities disclosed herein.

In some embodiments, specific components of referral processor 106 may be further configured to implement specific portions of referral processor 106. For example, components of referral processor 106 may be implemented in different types of logic, hardware, or as different processing nodes that operate in conjunction. For example, profile data aggregator 108 may be implemented as a first processing node, connectivity metric generator 110 may be implemented as a second processing node, and referral processing engine may be implemented as a third processing node. In some embodiments, profile data aggregator 108 may be implemented using one or more processors and hardware specifically configured to process large amounts of data. For example, profile data aggregator 108 may be implemented using numerous central processing unit (CPU) cores, a large amount of random access memory (RAM), fast disk drive arrays with advanced caches to facilitate disk access, and may also be implemented as part of a grid computing system. Profile data aggregator 108 may also be configured to include one or more hardware accelerators configured to further facilitate processing of such large data sets. Similarly, connectivity metric generator 110 may include one or more hardware accelerators dedicated to facilitating the generation of connectivity metrics discussed in greater detail below. Furthermore, referral processing engine 112 may also include one or more processors operating in conjunction with hardware accelerators. Inn some embodiments, the processors and hardware accelerators may be pipelined to further facilitate the generation of communications messages, handle network traffic associated with those communications messages, and update large data tables of data values associated with those messages that may be stored in a data storage system, such as data storage system 114. In this way, referral processor 106 and its components may be configured specifically and particularly to implement the embodiments disclosed herein.

As discussed above, referral system 100 may further include data storage system 114 which may be configured to store data underlying one or more referral methods implemented by referral system 100. For example, data storage system 114 may store and maintain the candidate profile data as well as any associated data, such as connectivity metrics associated with the candidates. In various embodiments, data storage system 114 may be implemented as a database system or a distributed file system. While referral system 100 is shown as including one instance of data storage system 114, it will be appreciated that data storage system may be implemented across many instances in many database systems of file systems.

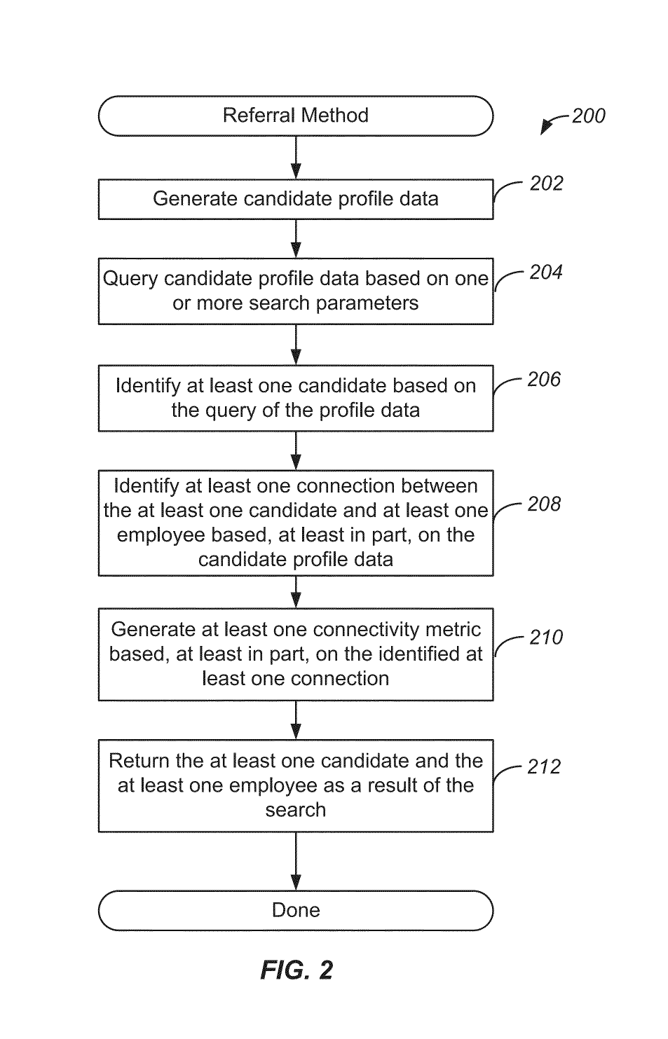

FIG. 2 illustrates a flow chart of an example of a method for facilitating the referral of a candidate, implemented in accordance with some embodiments. As similarly discussed above, various systems and devices as disclosed herein may be implemented to enable a recruiter at a particular company to identify potential candidates for an opening at the company through various connections that may be associated with the candidates. For example, a method, such as method 200, may include generating candidate profile data by combining various sets of data which may include social data, as well as candidate data that describes or characterizes the candidate's professional experience and other online contributions to publicly available websites, products, and systems. The method may further include searching the candidate profile data for prospective candidates, identifying connections associated with the prospective candidates, generating one or more connectivity metrics based, at least in part, on the candidate profile data, and presenting results of the search to the recruiter.

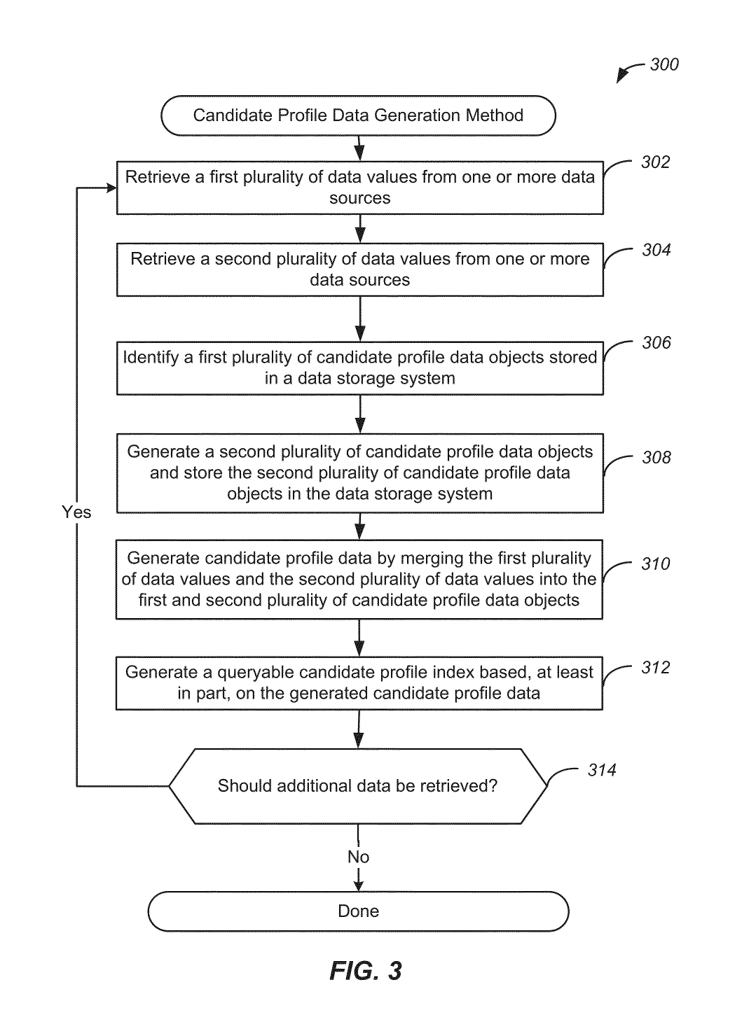

Accordingly, method 200 may commence with operation 202 during which candidate profile data may be generated. As similarly discussed above, candidate profile data may be generated by aggregating data from various different sources, such as social networking sites, employee databases, as well as other publicly accessible data sources, and mapping the data to particular data objects stored in a data storage system. The candidate profile data may include one or more data values that describes or characterizes the candidate's professional experience, biographical data, and other online contributions to publicly available websites, products, and systems. The candidate profile data may further include social graph connection data that describes or characterizes an employee's relationships with candidates. The generation of candidate profile data is discussed in greater detail below with reference to FIG. 3.

Method 200 may proceed to operation 204 during which the candidate profile data may be queried based on one or more search parameters. In various embodiments, the search parameters may be one or more data values received from an entity, which may be a user of a referral system, as discussed above with reference to FIG. 1. The search parameters may include one or more keywords that may be entered by a recruiter at a company. In some embodiments, the keywords may be associated with the position or opening that the recruiter is trying to fill. For example, the recruiter may enter keywords such as “Python” and “programmer” to initiate a search for potential candidates that are software programmers capable of programming in Python. In this example, the words “Python” and “programmer” may be received by a system component as search parameters.

Method 200 may proceed to operation 206 during which at least one candidate may be identified based on the one or more search parameters. As discussed above, the candidate profile data may include various biographical and professional information associated with various candidates. In various embodiments, the candidate profile data may also include information identifying skills, interests, and aspirations of candidates. Accordingly, candidate profile data may further include forward looking data that characterizes future interests and potential developments associated with candidates. Accordingly, one or more data fields of the candidate profile data may be queried based the received search parameters. Data objects including candidate profiles that have data values matching the search terms may be returned as a result of the query. Moreover, associated data may be returned as well. For example, the entire contents of the candidate profile data object associated with the matching candidate may be returned and subsequently analyzed by a referral system.

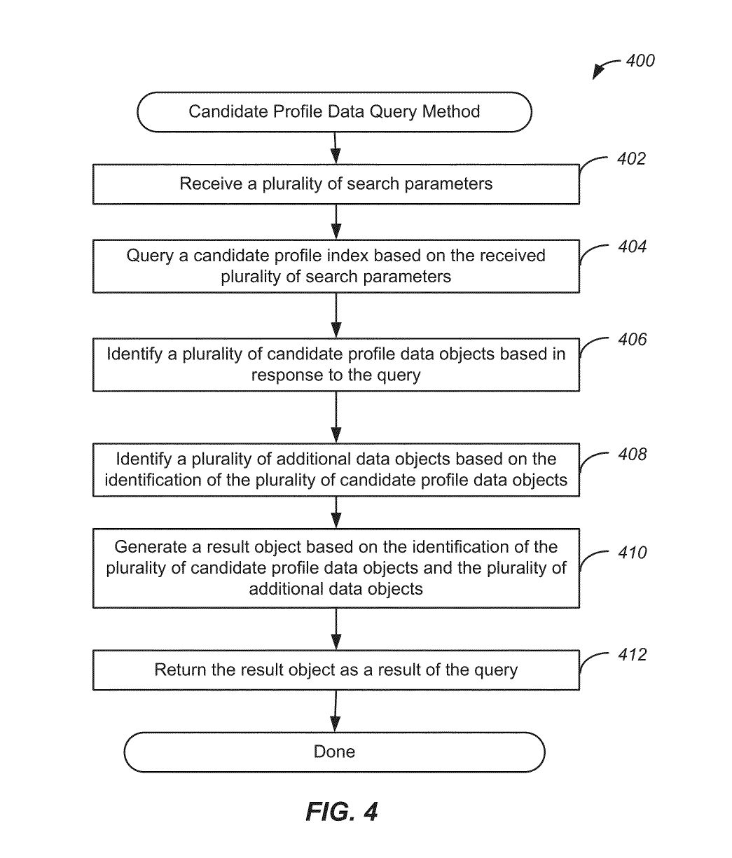

Method 200 may proceed to operation 208 during which at least one connection associated with at least one candidate may be identified. Accordingly, the returned candidate profile data may be analyzed to identify connections between each returned candidate and any employee at a company. In some embodiments, the company may be the same company to which a recruiter that initiated method 200 belongs. In various embodiments the connections may be identified based on existing social connections in social networks as may be determined based on user profile data retrieved from one or more data sources, such as Facebook®. The identifying of connections is discussed in greater detail below with reference to FIG. 4.

In various embodiments, method 200 may further include querying one or more employees based on the previously identified candidates. Thus, employees connected to the identified candidates may be sent a message which prompts the employees for feedback or comments regarding one or more identified candidates. In response to receiving the message, the employees may provide an input which may be returned as another message. In some embodiments, the input may identify whether or not one or more employees would recommend the candidate associated with the message for the job opportunity that may be associated with the referral. In various embodiments, one or more data values associated with the previously identified candidates may be filtered based on the input received from the employees. For example, only candidates receiving favorable feedback may be selected and incorporated in subsequent referral operations, as will be discussed in greater detail below. In this way, one or more referral methods disclosed herein, such as method 200, may optionally include the querying of one or more employees to filter candidates associated with the referral methods.

Method 200 may proceed to operation 210 during which one or more connectivity metrics may be generated based, at least in part, on the identified at least one connection. As similarly discussed above, a connectivity metric may describe or characterize a relative strength of a connection between a candidate and another entity, such as an employee of a company. For example, a primary connection may be a relatively strong connection in which a candidate and employee directly know each other. A secondary connection may be a relatively weaker connection in which the candidate and employee do not know each other, but both know the same person or people. Accordingly, one or more connectivity metrics may be generated that identify a number of primary and secondary connections, as well as any other connections, exist between a candidate and each employee of the company. In various embodiments, the metrics may be stored in a data storage system. The generating of connectivity metrics is discussed in greater detail below with reference to FIG. 4.

Method 200 may proceed to operation 212 during which the results of the search may be presented at a display device. The results of the search may be presented to a recruiter that may have initiated method 200. In various embodiments, the results of the search may include a list of candidates that were identified as well as connection data identifying any connections between each of the candidates and employees of the company. Accordingly, details of each connection may be presented in the display as well. Moreover, the presentation of the results may be sorted, arranged, ranked, and/or filtered based on the connectivity metrics and one or more designated settings. For example, the list of candidates may be ranked in descending order based on their respective connection strengths to the employees and company. Furthermore, one or more designated settings may be previously configured to only display the top 5, 10, or 20 results. In various embodiments, results may also be filtered based on various filtering parameters, such as specific skills, years of experience, an industry, and/or a company. Such filtering may be implemented dynamically an in response to an input provided by an entity, such as a recruiter. In this way the results of the search may be presented to the recruiter in a display that includes candidates matching the previously provided search criteria, where the candidates are sorted by their respective connection strengths, potentially filtered based on additional filtering parameters, and the referral system may provide information about each candidate's social connections to employees thus identifying the best employees to provide referrals for each respective candidate.

FIG. 3 illustrates a flow chart of an example of a method for generating candidate profile data, implemented in accordance with some embodiments. As similarly discussed above a referral system, such as a referral system provided by The One Page Company Inc., may be configured to enable a recruiter to search for candidates that are connected to employees via various different social connections. To enable such a search, candidate profile data may be generated by gathering and combining data from various different sources with social connection data. Furthermore, such data may be stored in a data storage system and a queryable index data object may be generated to enable efficient access to the candidate profile data.

Accordingly, method 300 may commence with operation 302 during which a first plurality of data values may be retrieved from one or more data sources. In various embodiments, the first plurality of data values may include data retrieved from various social networking and social media services that may be associated with employees of the company. In some embodiments, the first plurality of data values may be retrieved from user profiles belonging to the employees, and may include social connections associated with the employees. Thus, the first plurality of data values may identify several potential candidates who are socially connected to the employees of the company. Accordingly, a system component, such as a profile data aggregator, may be configured to crawl one or more social networking or social media websites and retrieve social connection data for each employee that has a user profile on the social networking or social media website.

Method 300 may proceed to operation 304 during which a second plurality of data values may be retrieved from one or more data sources. In various embodiments, the second plurality of data values may include additional data associated with each candidate that was identified during operation 302. Accordingly, during operation 304, a system component, such as a profile data aggregator, may retrieve various data that may include one or more portions of candidate data characterizing one or more biographical, personal, and/or professional features of a candidate. In some embodiments, the data sources may be queried and one or more data values may be retrieved that identify various candidates' names, professional titles, geographical locations, and/or contact information. As previously discussed, the candidates for which data is retrieved may be identified based on the connections identified by the first plurality of data values. In this way, data associated with potential candidates may be enriched by querying various different data sources to augment data available in a database system for each potential candidate. In some embodiments, the queried data sources may include any suitable data source. For example, the data sources may include social networks, identity verification systems, as well as third party data providers.

Method 300 may proceed to operation 306 during which a first plurality of candidate profile data objects stored in a data storage system may be identified. In some embodiments, candidate profile data objects may be data structures or records that are configured to include one or more data fields capable of storing retrieved data associated with one or more candidates. In some embodiments, a candidate profile data object may be uniquely associated with a particular candidate, and may store all candidate profile data associated with that candidate. In various embodiments, the first plurality of candidate profile data objects may be stored in a data storage system and may have been previously generated by a referral system during a previous iteration of a referral method. For example, a referral method may have been previously implemented, and a candidate profile data object may have been previously generated for a particular candidate. In this example, if additional data is retrieved for that candidate during operation 302 and/or operation 304, the previously generated candidate profile data object may be identified and subsequently updated with new data, as discussed in greater detail below.

Method 300 may proceed to operation 308 during which a second plurality of candidate profile data objects may be generated and stored in the data storage system. In various embodiments, if no candidate profile data objects have been previously generated for a particular entity, such as a candidate, new candidate profile data objects may be generated. Accordingly, a system component, such as a profile data aggregator, may generate new data objects that store retrieved candidate profile data for any newly identified candidates.

Method 300 may proceed to operation 310 during which candidate profile data may be generated by merging the first plurality of data values and the second plurality of data values into the first and second plurality of candidate profile data objects. Accordingly the data retrieved during operations 302 and 304 may be mapped to one or more candidate profile data objects stored in a data storage system, thus updating the candidate profile data objects with the most recent profile information and social connection information available. In various embodiments, such mapping may be based on common identifiers found across various data objects. Moreover, correlations or relationships between identifiers may be inferred or determined, and may be used to map identifiers from disparate data sources to each other, and merge data values as described above. Such inferring of relationships may be determined based on approximate matching, identifier reconciliation, importing mappings from third party data sources, and/or machine learning components analyzing previous reconciliations. In some embodiments, a master data management framework may be specifically configured to facilitate the storage and management of the candidate profile data.

Method 300 may proceed to operation 312 during which a queryable candidate profile index may be generated based, at least in part, on the generated candidate profile data. In various embodiments, the index may be a data structure configured to increase a speed associated with retrieval operations. In particular embodiments, the candidate profile index may include the names of candidates associated with the candidate profile data objects, and/or unique identifiers associated with those candidates. In some embodiments, the candidate profile index may include a searchable representation of candidates as well as their associated social connections, e.g. who they know and who they are connected to on a social graph. Furthermore, the candidate profile index may be implemented with additional hardware acceleration, as may be accomplished by dedicated hardware accelerators, to facilitate execution of candidate profile data queries.

Method 300 may proceed to operation 314 during which it may be determined whether or not additional data should be retrieved. Such a determination may be made based on one or more system configurations, or based on an input provided by an entity, such as a recruiter. For example, a recruiter may be provided with a user interface which may be configured to receive an input that indicates additional data should be retrieved. Moreover, additional data may be retrieved automatically as part of a periodic data retrieval method that repeats after a designated period of time. If it is determined that additional data should be retrieved, method 300 may return to operation 302 and method 300 may repeat. If it is determined that no additional data should be retrieved, method 300 may terminate.

FIG. 4 illustrates a flow chart of an example of a method for searching candidate profile data, implemented in accordance with some embodiments. Searching candidate profile data may be implemented as a part of a referral method in which candidates relevant to a recruiter's inquiry are identified, and information or data associated with those candidates is retrieved and returned as a response to the recruiter's inquiry. In various embodiments, the information retrieved and the arrangement or presentation of the data may be configured based upon the search initiated by the recruiter.

Accordingly, method 400 may commence with operation 402 during which a plurality of search parameters may be received. As discussed above, the plurality of search parameters may be received from a user of a referral system that has initiated a referral method. For example, the search parameters may be received from a recruiter. The search parameters may be received at a console server via a user interface provided to the recruiter. Moreover, the search parameters may include one or more keywords associated with an opening or position that the recruiter is attempting to fill.

Method 400 may proceed to operation 404 during which a candidate profile index may be queried based on the received plurality of search parameters. As previously discussed, the candidate profile index may be a data structure that has been generated based, at least in part, one or more features or characteristics of the candidate profile data objects. Accordingly, during operation 404, the candidate profile index may be queried, and the candidate profile data objects may be searched to determine whether or not any of the candidate profile data objects match the received search parameters.

Method 400 may proceed to operation 406 during which a plurality of candidate profile data objects may be identified based in response to the query. Accordingly, if the candidate profile data objects include one or more data values that match the received search parameters, the matching candidate profile data objects may be identified and included as results of the query. In various embodiments, the candidate profile data objects may be identified based on various other data in addition to the search parameters. In some embodiments, one or more features or characteristics of a company or organization associated with an employment opportunity underlying the search may be used to identify candidates. For example, various characteristics of the company, such as an industry, a size, a strategy, a location, recent actions or initiatives taken, and a market may also be used to identify candidate profile data objects. Thus, organization data characterizing such characteristics of the company or organization may be used to augment the set of search parameters and may also be used to execute the query. In some embodiments, system components may be configured to predictively identify additional candidate profile data objects based on an analysis of the organization data. For example, one or more machine learning components may identify additional parameters or features of candidate profile data objects often selected by organizations with similar characteristics, and may use the additional parameters to augment the search.

Method 400 may proceed to operation 408 during which a plurality of additional data objects may be identified based on the identification of the plurality of candidate profile data objects. In some embodiments, the additional data objects may include data values or data records that provide additional contextual information associated an identified candidate and the identified candidate's qualifications. For example, if a candidate has been identified based on his or her knowledge of a particular programming language, additional data objects may be retrieved that identify or include publications or other contributions generated by that candidate. The additional objects may include the publications themselves, or may include a link to the publications. In this way, data characterizing the candidate as well as his or her accomplishments and contributions may be retrieved. It will be appreciated that such data may be retrieved from various social networking sites as well as other online data sources, and such data may also include other contextual data retrieved from such data sources.

Method 400 may proceed to operation 410 during which a result object may be generated based on the identification of the plurality of candidate profile data objects and the plurality of additional data objects. Accordingly, the identified candidate profile data objects and additional data objects may be packaged into a data structure, such as a result object, that may be subsequently processed during additional portions of a referral method. In various embodiments, the result object may be specifically configured to be displayed on a display device of a data processing system, and may be further configured to enable selection, sorting, and filtering functionalities described in greater detail below.

Method 400 may proceed to operation 412 during which the result object may be returned as a result of the query. In some embodiments, the result object may be returned to the entity that initiated the query, which may be a recruiter. In various embodiments, a system component, such as a rendering engine, may render one or more portions of the result object to generate a graphical representation of at least some of the candidate profile data included in the result object. In this way, at least some of the retrieved data may be presented to the recruiter as a result of the recruiter's search.

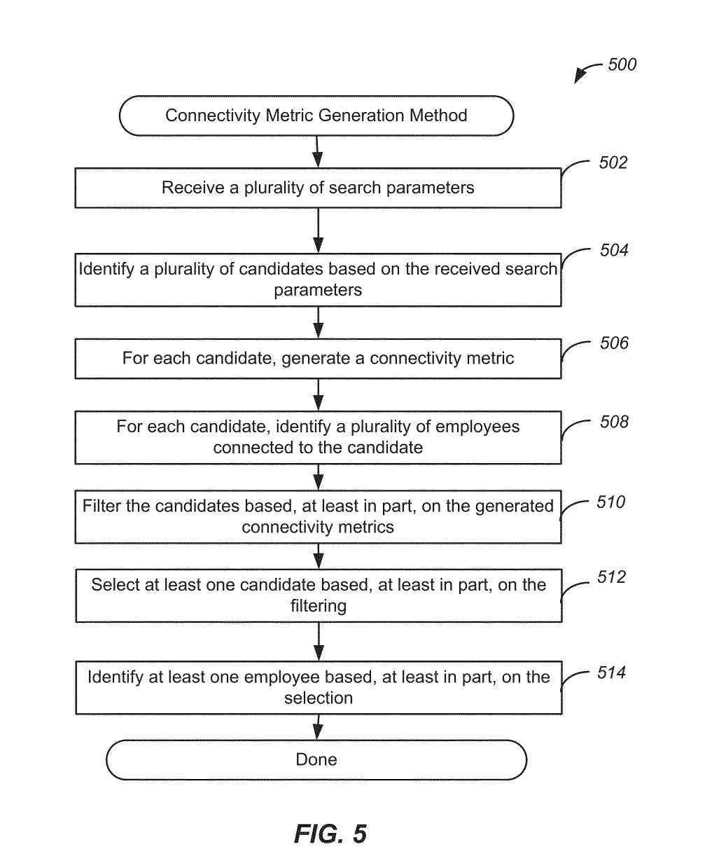

FIG. 5 illustrates a flow chart of an example of a method for generating a connectivity metric, implemented in accordance with some embodiments. As similarly discussed above, a connectivity metric may describe or characterize a strength of a connection between a candidate and one or more employees, as well as a company that employs the employees. Furthermore, the connectivity metric may form the basis of a report or display presented to a user of a referral system, which may be a recruiter. Accordingly, a system component may use the connectivity metric to arrange the candidates presented to the recruiter such that the candidates that have the strongest connections to the company are featured most prominently.

Method 500 may commence with operation 502 during which a plurality of search parameters may be received. As discussed above, the plurality of search parameters may be received from user of a referral system that has initiated a referral method. For example, the search parameters may be received from a recruiter. The search parameters may be received at a console server via a user interface provided to the recruiter. Moreover, the search parameters may include one or more keywords associated with an opening or position that the recruiter is attempting to fill.

Method 500 may proceed to operation 504 during which a plurality of candidates may be identified based on the received search parameters. As similarly discussed above, candidate profile data may be queried to identify relevant candidates for the position that the recruiter is attempting to fill. Thus, the candidate profile data that may have been previously generated by combining data from various different data sources, such as social media websites, may be queried, and several candidate profiles may be identified and retrieved for further analysis.

Method 500 may proceed to operation 506 during which a connectivity metric may be generated for each identified candidate. In various embodiments, the identified candidate profile data objects may be analyzed to generate a connectivity metric for each candidate. For example, a candidate profile data object may be analyzed to identify a number of connections, such as social connections, between the candidate associated with the candidate data profile and various other entities, such as employees of a particular company. As previously discussed, such social connections may have been identified and/or inferred based on data aggregated from various different online and offline data sources.

In various embodiments, the candidate profile may be further analyzed to identify various connectivity characteristics that may be associated with each identified connection. In some embodiments, a connectivity characteristic may characterize a type, strength, duration, and/or activity level associated with a connection. For example, as discussed in greater detail below, the connectivity characteristic may indicate that a social connection is a “friend” type connection that is a first-order connection. Accordingly, a connectivity characteristic may refer to or identify any facet of the one or more data values identifying the social connection that is being analyzed. As discussed in greater detail below, connectivity characteristics may specify whether or not an identified connection is a first degree connection (entities are directly connected), a second degree connection (entities share a same mutually connected entity, such as a mutual friend), or even a third degree connection. Connectivity characteristics may also be generated that identify or infer additional features of connections, such as attending the same university or school, originating from the same geographical location, and/or belonging to the same social groups.

In some embodiments, connectivity weights may be generated based on the connectivity characteristics. Accordingly, a connectivity weight may be generated and assigned to a social connection between entities, such as a candidate and an employee, based on its connectivity characteristic. In some embodiments, a connectivity characteristic may be an indicator of a connection strength, and may be determined based on a single variable. Such a connection strength may be a first order connection strength. As will be discussed in greater detail below, a weight may be determined based on one or more characteristics of the connection between entities, as well as one or more characteristics of the entities themselves.

For example, connectivity weights may be determined based on whether or not the connections are first order, second order, or even third order. In this example, first order connections may be given highest weight, and second and third order connections may be given lower weights respectively. Furthermore, particular types of connections may be weighted more, such as “friend” and “relative”. Accordingly, such connectivity characteristics that characterize facets of the identified social connections may be mapped to connectivity weights based on a designated mapping. In some embodiments, such a mapping may be generated and determined by one or more system components, such as a referral processor. Accordingly, a predetermined mapping may be used to translate connectivity characteristics to connectivity weights which may subsequently be used to generate connectivity metrics, as discussed in greater detail below.

Furthermore, various connection strengths or scores may be determined based on the connectivity weights to provide a weighted combination of multiple identified social connections. Such connection strengths or scores may be specific to a particular employee-candidate pair, and may underlie an overall connectivity metric generated for that candidate, as discussed in greater detail below. For example, if a candidate and an employee attended the same university and/or high school and/or grew up in the same city, then such connection information or data may be identified, and used to generate a connectivity weight for the connection. Similarly, any other connections between the candidate and employee may be identified and used to generate connectivity weights. The different connectivity weights may be combined in accordance with equation 1 shown below:

ECS(x)=Ax₁+Bx₂+Cx₃+ . . . +Dxₙ (1)

Accordingly, as shown by Equation 1, the employee connection strength (ECS) may be equal to a weighted linear combination of multiple variables that each represent a different connection between a specific employee and candidate. In various embodiments, the variables, such as x₁, x₂, etc. may represent identified social connections between the employee and candidate. For example, if 3 connections are identified between an employee and a candidate, they may be represented by variables x₁, x₂, and x₃. The coefficients associated with the variables such as A, B, C, and D, may be weighted coefficients that weight each identified connection when generating the overall connection strength. In various embodiments, the coefficients may be the previously discussed connectivity weights. Thus, according to some embodiments, the values of such coefficients may be determined based on a designated mapping scheme. Such a mapping scheme may have been determined by an entity, such as a recruiter or an organization, or may have been determined based on previous activity associated with a recruiter or an organization, such as previous selections of candidates made and previous search parameters used.

Furthermore, the determination of connectivity weights and connectivity metrics may also take into account additional connections that may characterize company-candidate relationships. In some embodiments, a company may indicate that specific company-specific experience in a candidate's background should be emphasized. For example a specific accreditation or previous company employment may be emphasized, and such information may be utilized to weight a determination of a company connection strength. Thus, company-candidate connections may be identified and used to generate additional connectivity characteristics and weights, as similarly discussed above. Furthermore, such company-candidate connections may be combined to generate company connection strengths or scores. An example of an equation that accounts for multiple company-candidate connections is shown in Equation 2 below:

CCS(y)=Ay₁+By₂+Cy₃+ . . . +Dyₙ (2)

Thus as illustrated above the company connection strength (CCS) may be equal to a weighted linear combination of multiple company-candidate connections. As similarly discussed above, identified connections may be represented in the equation by variables, such as y₁, y₂, etc., and coefficients associated with the variables such as A, B, C, and D, may be weighted coefficients that weight each identified connection when generating the overall connection strength. As similarly discussed above, values of such coefficients may be determined based on a designated mapping scheme that may have been determined by an entity, such as a recruiter or an organization, or may have been determined based on previous activity associated with a recruiter or an organization, such as previous selections of candidates made and previous search parameters used.

Accordingly, the connections between candidates and employees, as well as candidates and companies or organizations, may be assigned connectivity weights based on their respective connectivity characteristics, and such connectivity weights may be used to determine an overall connection strength. Thus, as will be discussed in greater detail below, the connectivity weights may form the basis of the determination of connectivity strengths or scores, and such scores may be combined to generate connectivity metrics that describe or characterize an overall strength of a connection between a candidate and employee and/or company.

In various embodiments, connectivity metrics may be generated based on a combination of one or more connectivity weights. In various embodiments, the connectivity metric may characterize or identify how connected a particular candidate is to an employee and/or company. The connectivity metric may be generated by analyzing all connections between a candidate and employees of the company. In some embodiments, the connectivity metric may be a combination of all of the weighted connections associated with the candidate. More specifically, the connectivity metric may be a combination of all employee connection scores and company connection scores associated with a particular candidate. In some embodiments, the combination may be a weight sum or average. In this way the connectivity metric may be an overall metric or score generated based on all underlying connections between the candidate and employees as well as companies and organizations. In some embodiments, the connectivity metric may be normalized and may be represented in a logarithmic or linear scale. In various embodiments, a graphical representation of the connectivity metric may be rendered for display in a display device of a computer system. Thus, a graphical representation of the connections may be rendered and displayed to an entity, such as the recruiter.

Method 500 may proceed to operation 508 during which a plurality of employees connected to a candidate may be identified for each candidate. In some embodiments, employees most connected to a candidate may be identified for each candidate being analyzed. The most connected employees may be identified based on their connection scores and/or metrics. For example, employees having the highest employee connection scores may be identified during operation 508 for each candidate being analyzed. Accordingly, a list of employees connected to each candidate may be stored in a data table or a separate data object for subsequent analysis.

Method 500 may proceed to operation 510 during which the candidates may be filtered based, at least in part, on the generated connectivity metrics. Accordingly, the candidates that were identified based on the received search parameters may be filtered or sorted based on their associated connectivity metrics. In some embodiments, the candidates may be ranked in descending order such that the candidates having the largest or strongest connectivity metrics are positioned in the foremost positions of a data object, which may be a list. Similarly, candidates having the smallest or weakest connectivity metrics may be positioned towards the end of the list. In this way, the identified candidates relevant to the recruiter's search may be arranged such that the candidates having the largest and strongest connectivity metrics are presented first.

Method 500 may proceed to operation 512 during which at least one candidate may be selected based, at least in part, on the filtering. In various embodiments, the at least one candidate may be selected based on an input received from an entity, such as the recruiter. For example, the recruiter may be presented with a graphical representation of the filtered candidates and the recruiter may provide an input to a console server based on the information included in the graphical representation. In some embodiments, the input may select a particular candidate that the recruiter has decided to target for the referral method. In various embodiments, the selection may be made automatically. For example, the referral system may be configured to automatically select the highest ranked candidate, or the top five highest ranked candidates. In some embodiments, the selection of the at least one candidate may be based on various other features associated with the candidates described above as may be identified by candidate profile data, such as various data characterizing aspects of social networking sites, other online sources of data, and even offline sources of data.

Method 500 may proceed to operation 514 during which at least one employee may be selected based, at least in part, on the selection. Accordingly, based on the selected candidate identified during operation 512, an employee may be identified and selected to be incorporated in the referral method. In various embodiments, the employee may be identified based on an analysis of the candidate profile data associated with the selected candidate. For example, additional connectivity metrics may be generated characterizing a strength of a connection between each of the employees connected to the candidate and the selected candidate, as may be identified by the previously described employee connection scores. The employees may be filtered, ranked, and/or arranged, and the employee with the largest or strongest additional connectivity metric may be selected. For example, if the selected candidate is connected to two employees where the first employee has a first degree connection and the second employee has a second degree connect, additional connectivity metrics may be generated that characterize the strength between the employees and the candidate. In this example, the first employee may have a stronger connectivity metric because he has a first degree connection. Accordingly, the first employee may be selected.

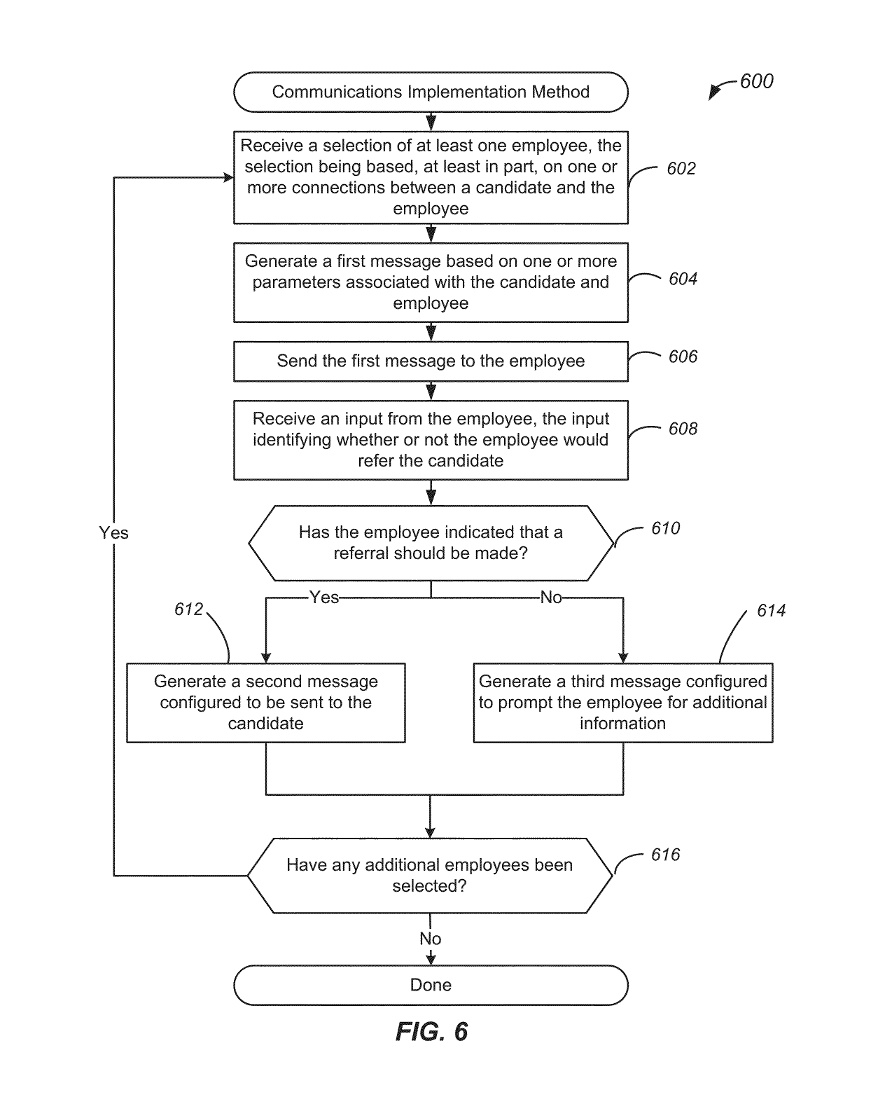

FIG. 6 illustrates a flow chart of an example of a method for implementing communications associated with the referral of a candidate in accordance with some embodiments. As similarly discussed above, a referral system may be implemented to automate communications that may be generated during a referral method. Accordingly, in addition to handling the transmission and receipt of messages, one or more system components may be configured to automatically generate messages based, at least in part, on inputs provided by a recruiter as well as candidate profile data. Moreover, the candidate profile data stored in a data storage system may be automatically updated based on inputs provided by the recruiter as well as employees and the candidate.

Accordingly, method 600 may commence with operation 602 during which a selection of at least one employee may be received. In some embodiments, the selection may be based, at least in part, on one or more connections between a candidate and the employee. As previously discussed above with reference to FIG. 4, an entity, such as a recruiter, may be presented with a list of candidates generated based, at least in part, on one or more identified connections between the candidates and employees. The recruiter may have selected a particular candidate and provided the selection to the referral system as an input via a console server. In some embodiments, the selection may identify several employees. Thus, several employees may be selected to take part in the referral process described in greater detail below.

Method 600 may proceed to operation 604 during which a first message may be generated based on one or more parameters associated with the candidate and the employee. In some embodiments, the first message may include one or more data fields that may be configured to display one or more text fields and graphical images. The first message may further include one or more data fields that may be configured to receive an input from the recipient of the first message, which may be the employee. Accordingly, the first message may be a data object configured to be rendered and displayed in a display device of a computer system. Moreover, the text included in the text fields may be generated based, at least in part, on parameters associated with the candidate and the employee. For example, the text may include a message asking the employee whether or not he or she would refer the candidate for a particular position or opening. The text may include the employee's name, candidate's name, details about the position, qualifications required for the position, and instructions regarding the referral method, all of which may be determined based on the search parameters initially received and the candidate profile data that was subsequently identified and analyzed.

Method 600 may proceed to operation 606 during which the first message may be sent to the employee. Accordingly, the generated first message may be sent to an employee that was selected during operation 602. The first message may be sent via and suitable communications technique. In some embodiments, the first message may be sent to the employee via a messaging system that is internal to the company, via an electronic mail service, or any other suitable messaging service. For example, the first message may be sent via text message or a messaging utility of a social messaging application that may be associated with an online social network.

Method 600 may proceed to operation 608 during which an input may be received from the employee. In some embodiments, the input may include one or more data values identifying whether or not the employee would refer the candidate for the opening or position. For example, the first message may include data fields configured to receive inputs from the employee indicating that the employee recommends the candidate, does not recommend the candidate, or does not know the candidate. The employee may provide an input, such as a mouse click that provides an input to a particular data field and is received as an input.

Method 600 may proceed to operation 610 during which it may be determined whether or not the employee indicated that a referral should be made. In various embodiments, a system component may interpret the input received from the employee and determine whether or not the referral should be made. For example, particular identifiers may be associated with each data field. Accordingly, an input may include an identifier specifying that the data field indicating “Yes” has been selected. In this example, method 600 may proceed with the referral method.

Accordingly, if it is determined that the employee has indicated that a referral should be made, method 600 may proceed to operation 612 during which a second message may be generated. As similarly discussed above with reference to the first message, the second message may include one or more text fields including automatically generated text configured based on the candidate profiled data and the employee's response. For example, the generated text may include a template message to be sent to the candidate that indicates that a job opportunity is open, and that the candidate is invited to contact a human relations department to pursue the opportunity. The second message may be sent to the candidate and the candidate may respond to the second message to indicate whether or not he or she is interested in the opportunity. In some embodiments, the response may be stored in a data storage system and used to update the candidate profile associated with the candidate. Moreover, if the candidate indicates he or she is interested, a hiring method may be automatically initiated.

Returning to operation 610, if it is determined that the employee has indicated that a referral should not be made, method 600 may proceed to operation 614 during which a third message may be generated. In various embodiments, the third message may include one or more text fields including text that prompts the employee for feedback, and may further include a data field in which the employee may enter why he or she has decided not to refer this candidate. As similarly discussed above, the appropriate candidate profile data may be updated based on the employee's feedback.

Method 600 may proceed to operation 616 during which it may be determined if any additional employees have been selected and should be contacted for the referral method. Such as determination may be made based on data included in the selection data received during operation 602. As similarly discussed above, such data may be stored in an ordered data object, such as a list, and progress of method 600 through the list may be monitored or tracked by a system component. For example, progress may be monitored by a state machine. If it is determined that additional employees should be contacted, method 600 may return to operation 604. If it is determined that no additional employees should be contacted, method 600 may terminate.

In this way numerous employees may be automatically identified and messaged regarding numerous different candidates for a position. As discussed above, candidate profile data may be used evaluate and identify hundreds if not thousands of candidates, and automate messaging with various employees associated with those candidates. Such employees may also be numerous, and may also number in the dozens to hundreds when such a referral process is implemented in large scales. Furthermore, candidate profile data may be updated for each candidate involved in the referral process. Accordingly, candidate profile data for hundreds if not thousands of candidates may be updated based on inputs received from various different employees. Thus, systems and devices as disclosed herein may be configured to include new functionalities that enable the implementation of such referrals on scales not previously possible.

While the operations described shown in FIG. 6 or any other flowchart figures are shown in a particular order, they may be performed in a different order. For example, in FIG. 2, operation 202 may be performed at any time and independent of operations 204-212. In this case, the operations 204-212 may be performed in parallel rather than in series. Similarly other operations disclosed herein may be performed in series, independently, or optionally.

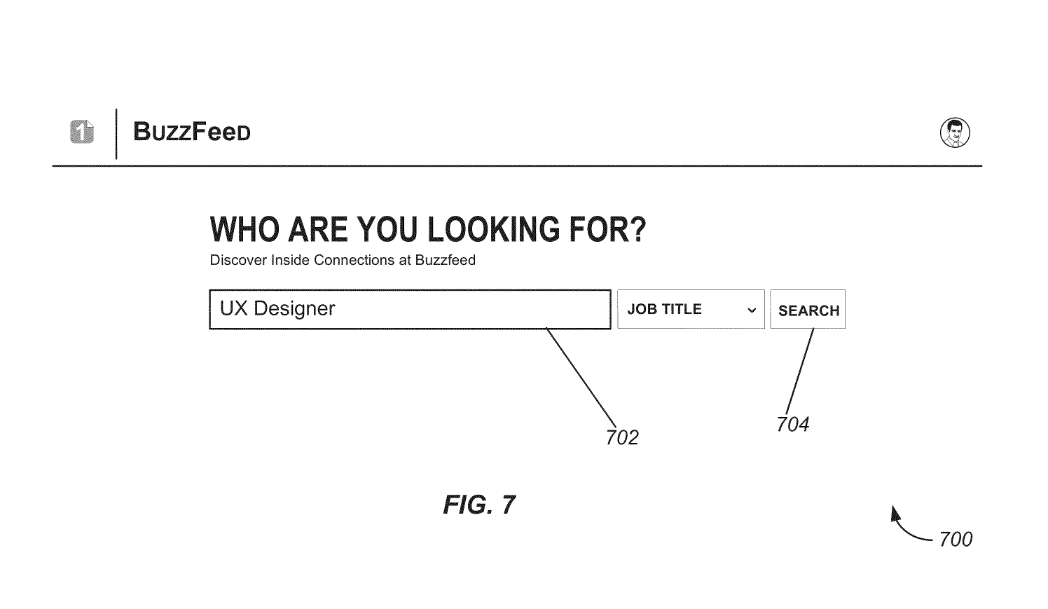

FIG. 7 illustrates a graphical representation of a user interface screen configured to receive one or more search parameters, implemented in accordance with some embodiments. As discussed above, one or more search parameters may be used to identify relevant candidates, and further identify connections between those candidates and employees of a company. As shown in FIG. 7, user interface screen 700 may include several data fields capable of receiving search parameters from an entity, such as a recruiter, and further capable to configure the search parameters via one or more drop down menus. In this example, the company is BuzzFeed®, and the recruiter is searching for candidates for an open position for a UX Designer. The recruiter may enter the search term or parameter “UX Designer” into data field 702 and provide an input, such as a click, to data field 704 to initiate the search.

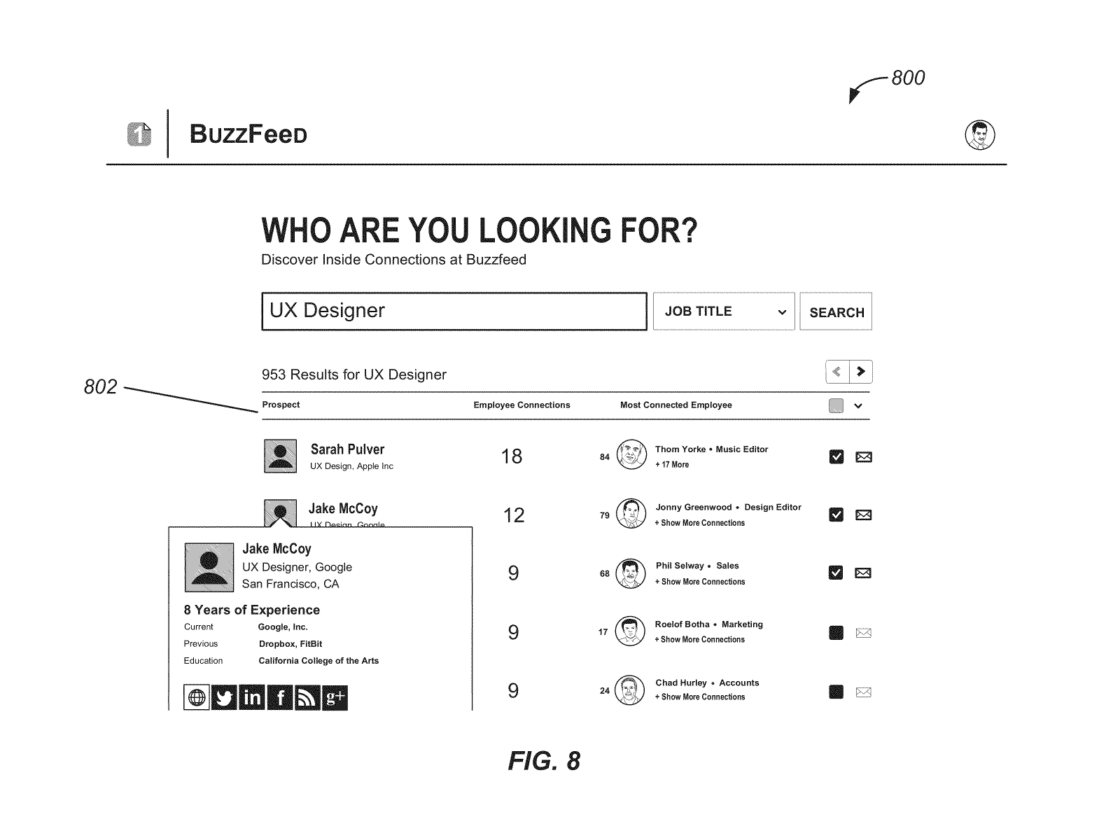

FIG. 8 illustrates a graphical representation of a user interface screen configured to display the results returned by a search, implemented in accordance with some embodiments. As similarly discussed above, a referral system, such as a referral system provided by The One Page Company Inc., returns results based on the received search parameters or criteria. The results screen may include an image, such as user interface screen 800, that may identify several relevant candidates that have been identified based on their correspondence to the search parameters. User interface screen 800 may further identify the candidates' connection strength to the company, and the employees connected to the candidates. As discussed above, the results may have been extracted from and generated based on the candidate profile data that contains information pulled from a variety of publicly available information. As shown in user interface screen 800, Jake McCoy's information was pulled from his own website, as well as various social networking sites and search engines. Moreover, of the 953 candidates identified and represented in data field 802, shown as the leftmost column, the candidates have been sorted based on their associated connectivity metrics, which may be a company connection strength. As previously discussed, the sorting may be performed based, at least in part, on previously determined social connection data. In this example, Sarah Pulver is sorted to the top of the list because she has a higher company connection strength than any other prospect, with 18 employee connections that may be represented in an associated social graph. Thus, Sarah is socially connected, i.e. “friends,” with 18 of the company's current employees. As previously discussed, while the connectivity metric shown in user interface screen 800 is determined based on social connections, additional types of connections may also form the underlying basis of the determination of the connectivity metrics. For example, the connectivity metric, which may be a company connection strength, may be determined based on a multivariate algorithm that incorporates other information into the determination of the connectivity metrics.

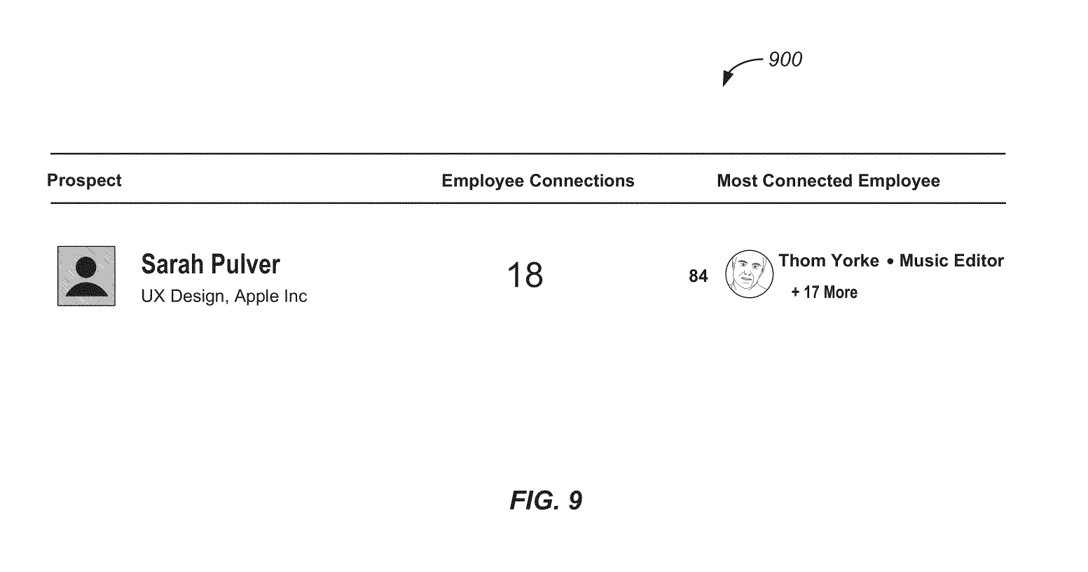

FIG. 9 illustrates a graphical representation of a user interface screen configured to receive a selection of an employee, implemented in accordance with some embodiments. As similarly discussed above, once the referral system has sorted the candidates based on their respective connectivity metrics, which may include a company connection strength, an employee may be selected based on the sorting. For example, the most connected employee may be selected via an employee connection strength algorithm. As similarly discussed above, the employee connection strength may be determined based on a number of social connections, or may be determined based on a multivariate algorithm that also analyzes other types of connection data. As shown in user interface screen 900, a candidate, Sarah, with the most social connections to the company has been chosen from the list that was presented in user interface screen 800 discussed above. Furthermore, an employee, Thom, has the most social connections to candidate Sarah and is the most connected employee to candidate Sarah because they share 84 social connections.

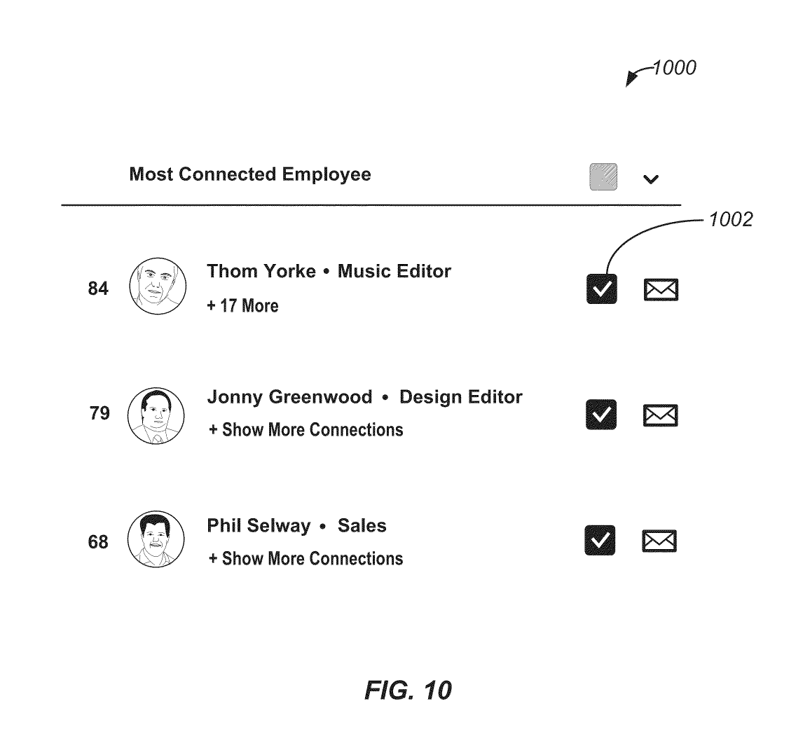

FIG. 10 illustrates a graphical representation of a user interface screen configured to receive a selection of a plurality of employees, implemented in accordance with some embodiments. As discussed above with reference to FIG. 8, the most connected employees to a candidate may be identified and presented to an entity, such as a recruiter. Accordingly, the recruiter may then select the matched employees and candidates to proceed to additional operations within a referral process. As shown in user interface screen 1000, the top several employees that are connected to a candidate, such as candidate Sarah, may be presented to the recruiter, and the recruiter may provide an input to a data field, such as data field 1002, to select several employees to be included in the referral process.

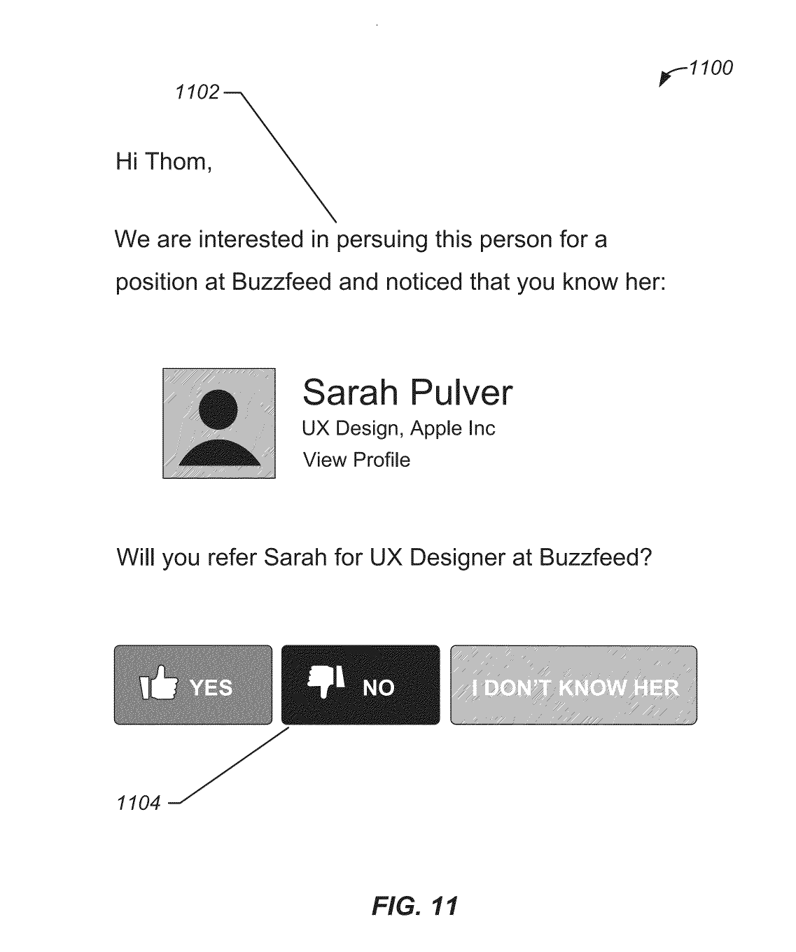

FIG. 11 illustrates a graphical representation of a user interface screen configured to provide a first message to an employee, implemented in accordance with some embodiments. As similarly discussed above, the first message may include one or more data fields that may be configured to display one or more text fields and graphical images. The first message may further include one or more data fields that may be configured to receive an input from the recipient of the first message, which may be the employee. Thus, user interface screen 1100 may be included in an internal email message that may be sent to a selected employee. User interface screen 1100 may include data field 1102 that includes a messaged configured based on the employee recipient. Moreover, user interface screen 1100 may include data field 1104 which may include one or more sub-fields configured to receive one or more inputs from the employee recipient. As shown in user interface screen 1100, the internal email may include information about the candidate and the specific role that the referral is for. The employee recipient Thom may view the candidate Sarah's profile, and may provide an input that selects “YES” to refer Sarah for the role, may provide an input that selects “NO” to not refer her, or may provide an input that indicates that he does not know Sarah well enough to make a referral by clicking on “I DON'T KNOW HER”.

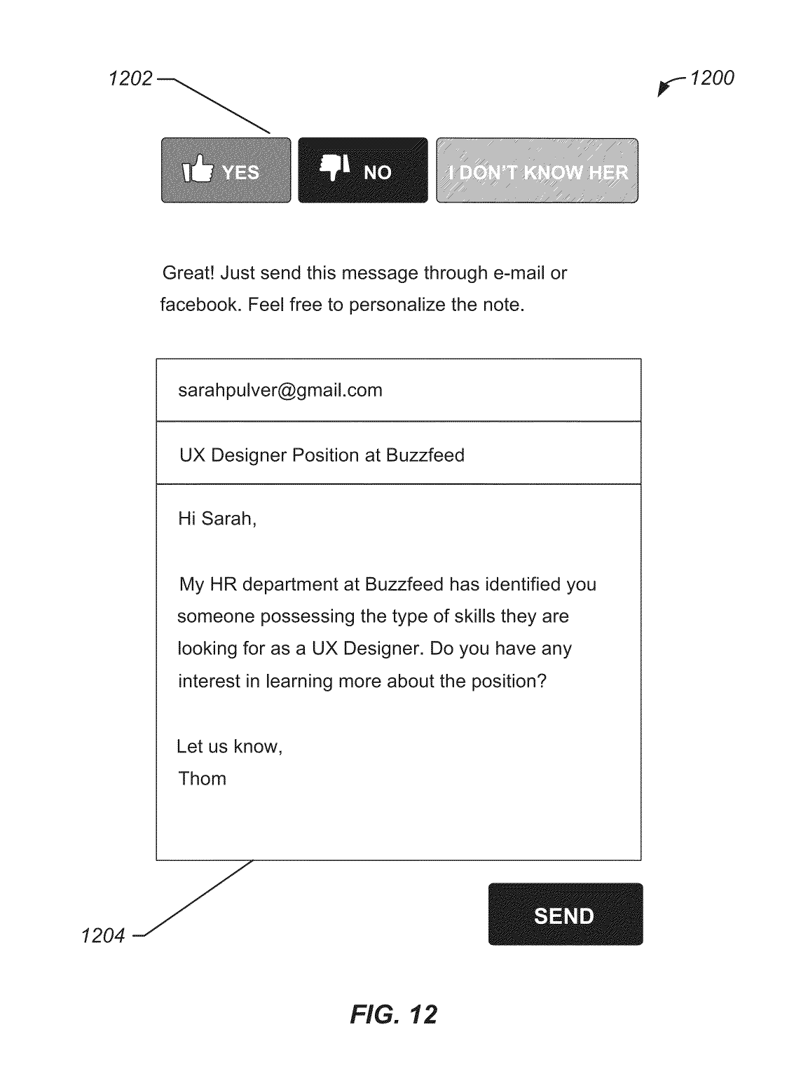

FIG. 12 illustrates a graphical representation of a user interface screen configured to provide a second message to an employee, implemented in accordance with some embodiments. The second message may be an entirely separate message from the first message. In some embodiments second message may be generated by re-rendering the first message to include one or more additional data fields responsive to an input provided by the employee recipient. According to various embodiments, user interface screen 1200 may include data field 1202 which displays a graphical representation of the input previously provided by the employee recipient. In this example, the Thom has selected “YES”. Accordingly, the second message has been rendered to include an additional data field, such as data field 1204, that includes an automatically generated template text message that Thom may edit or configure to further personalize prior to sending the message to the candidate. In some embodiments, and entity, such as the company, may configure the second message such that the template is locked and cannot be edited. Moreover, an entity, such as the company, may also enable the employee to send the message to the candidate via various different messaging systems, such as email, and/or Facebook message, and/or other suitable messaging techniques.

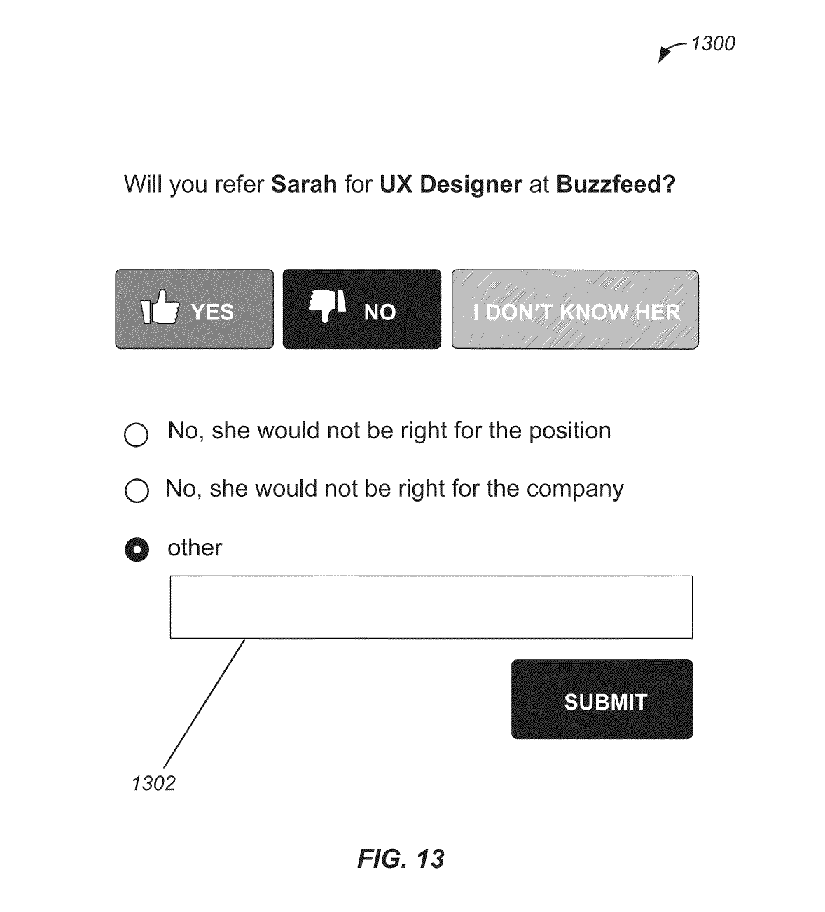

FIG. 13 illustrates a graphical representation of a user interface screen configured to provide a third message to an employee, implemented in accordance with some embodiments. As similarly discussed above, the third message may be an entirely separate message, or may be generated by re-rendering the first message to include one or more additional data fields responsive to an input provided by the employee recipient. As shown in user interface 1300, if the employee indicates a referral should not be made and clicks “NO”, the employee may be prompted to provide further feedback about the candidate. The employee feedback may be input into a data field, such as data field 1302, stored by the system, and provided back to the recruiter. Depending on one or more system configurations which may be determined by an entity, such as the company, an additional employee may be selected and asked for a referral, as described above with reference to the first message. In some embodiments, the additional employee may be the next most connected employee, and the selection and issuing of the message may be performed automatically. In some embodiments, the recruiter may be provided with a notification of the employees response, and the recruiter may be prompted to review and determine whether or not the candidate should be removed from the list of potential candidates, or whether the next most connected employee should be messaged. In some embodiments, if the employee clicks on “I DON'T KNOW HER” then the next most connected employee may be automatically selected and prompted for referral.

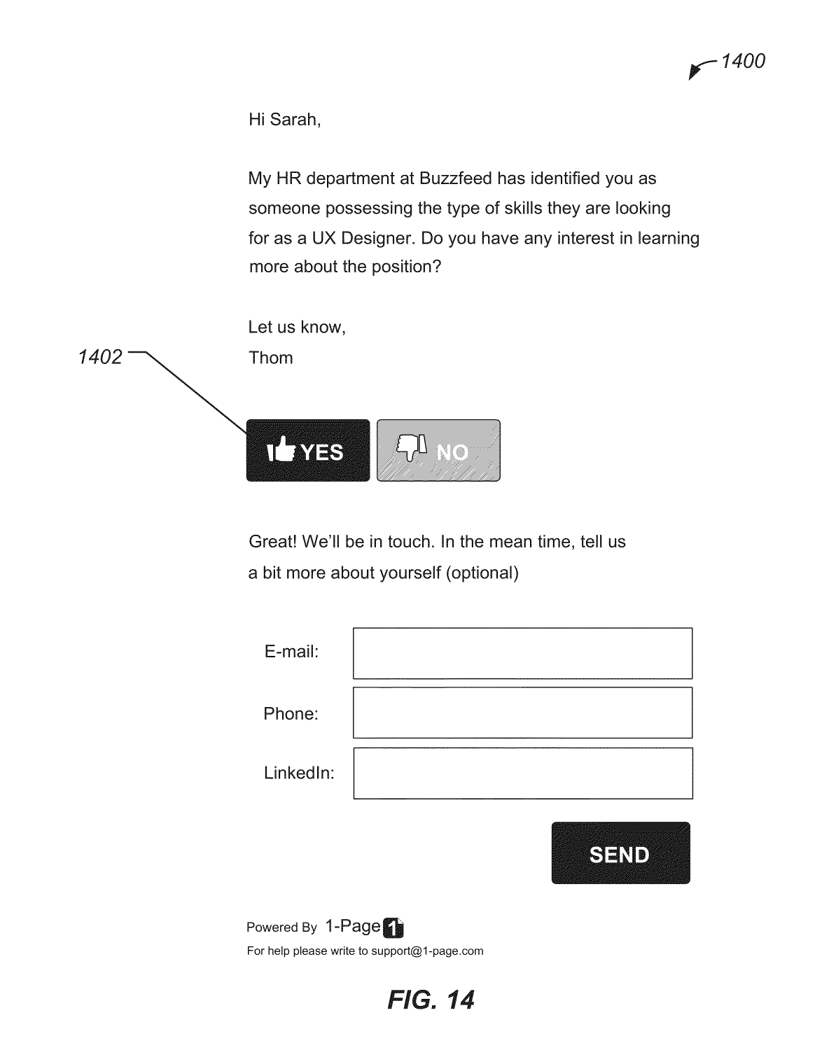

FIG. 14 illustrates a graphical representation of a user interface screen configured to provide a fourth message to a company, implemented in accordance with some embodiments. Accordingly, once a message has been sent to the candidate, the candidate may receive the message and may provide an input to one or more data field of a user interface screen, such as user interface screen 1400. For example, the candidate may provide an input to data field 1402 that selects “YES” or “NO”. If the candidate selects “YES”, then the candidate may be prompted to provide additional information, such as preferred contact information. In some embodiments, the additional information may be configured based on data not available in the candidate's candidate profile. Depending upon one or more system configurations, when the candidate's response is received, the candidate may be provided with a thank you page, or may be directed to a hiring method. If the candidate selects “NO”, the system may automatically generate a message that includes a customary message which may thank the user for his or her consideration and prompts them for feedback indicating why they are declining the invitation.

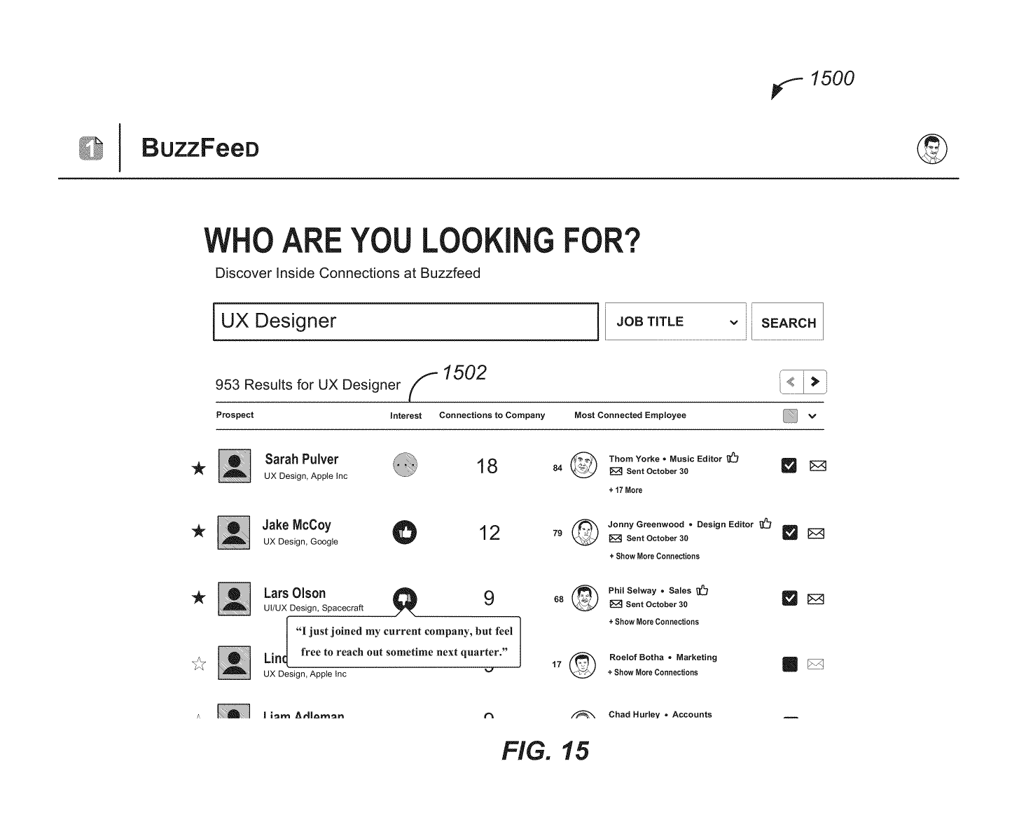

FIG. 15 illustrates a graphical representation of a user interface screen configured to display referral data associated with a referral method, implemented in accordance with some embodiments. Accordingly, a user interface screen, such as user interface screen 1500, may be provided to an entity, such as a recruiter. User interface screen 1500 may display various information that identifies an overall status of all active candidates and employee referrals that may be managed by a referral system. For example, as shown in data field 1502, the system is awaiting a response from candidate Sarah, has received a positive confirmation of interest from candidate Jake, and has been declined by candidate Lars due to his recent new employment. As discussed above, such information may be updated dynamically and in real time, thus providing the recruiter with an accurate representation of all pending referrals in real time.

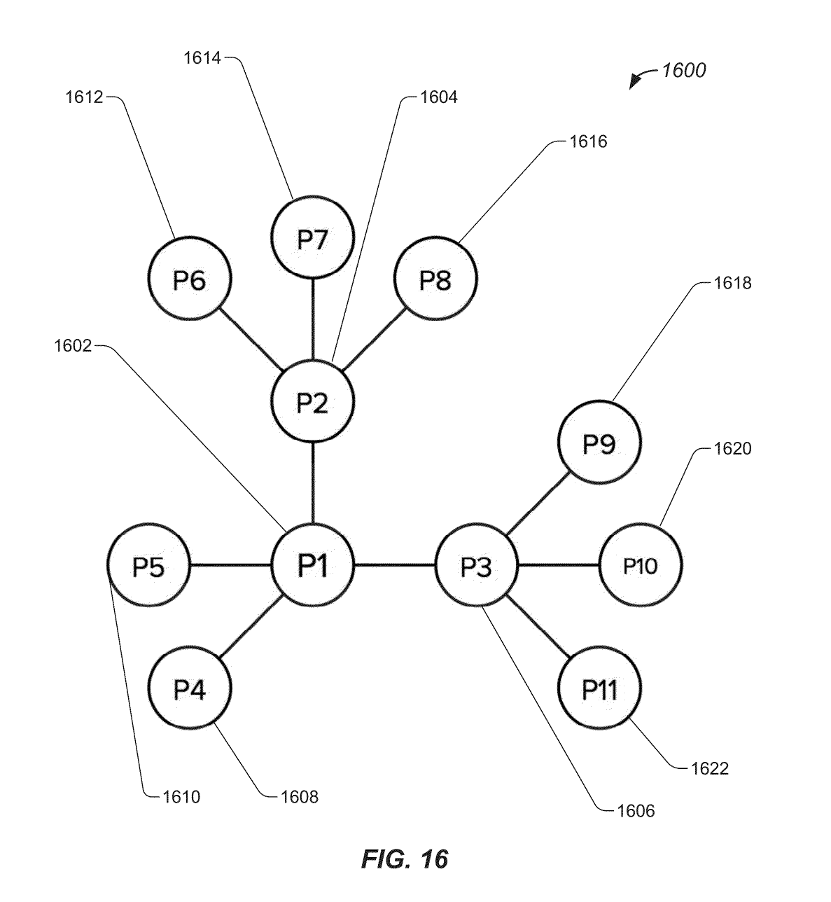

FIG. 16 illustrates a graphical representation of several social connections, implemented in accordance with some embodiments. As similarly discussed above, candidate profile data and/or social connection data may characterize or identify relationships, interactions, and commonalities between people on social networking websites. Accordingly, such data may identify: who is friends with who as well as who may be otherwise acquainted with who. As shown in FIG. 16, person P1 1602 may be connected to P2 1604, P3 1606, P4 1608, and P5 1610. In various embodiments, these social connections may be identified as first-degree or first-order connections and may be identified based on candidate profile data of person P1 as well as data associated with the other people, such as P2. For example, P1 and P2 may have gone to the same school, and such a school may be identified in social connection data that has been aggregated by both P1 and P2. Moreover, P1 and P2 may be connected with each other and may indicate that they know each other via one or more social networking sites. In some embodiments, P1 1602 may also be connected to persons P6 1612, P7 1614, P8 1616, P9 1618, P10 1620, and P11 1622 via second-degree or second-order connections. Such secondary connections may be further identified by additional data associated with P6, P7, etc. For example, candidate profile data associated with P6 may indicate that P6 is connected to P2. Accordingly, system components may be configured to identify a secondary connection between P1 and P6 because they both are connected to P2, and thus have a connection in common.

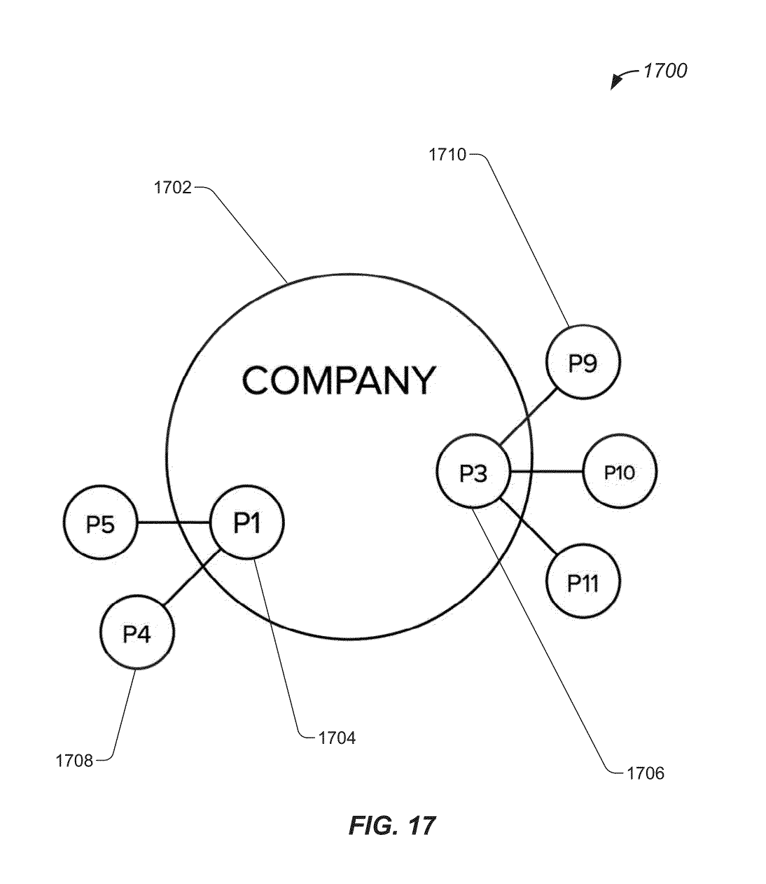

FIG. 17 illustrates a graphical representation of several social connections that may be associated with a company, implemented in accordance with some embodiments. As similarly discussed above with reference to FIG. 16, candidate profile data and/or social connection data may characterize or identify who knows who. As shown in FIG. 17, a company, such as company 1702, may include employees, such as P1 1704 and P3 1706, who may be connected to other people outside the company that may be candidates, such as P4 1708 and P9 1710. Accordingly, the graphical representation may be configured to illustrate connections and relationships between employees and candidates relative to a company, and in a way that distinguishes or identifies which entities are included within the company, and which entities are not included within the company.

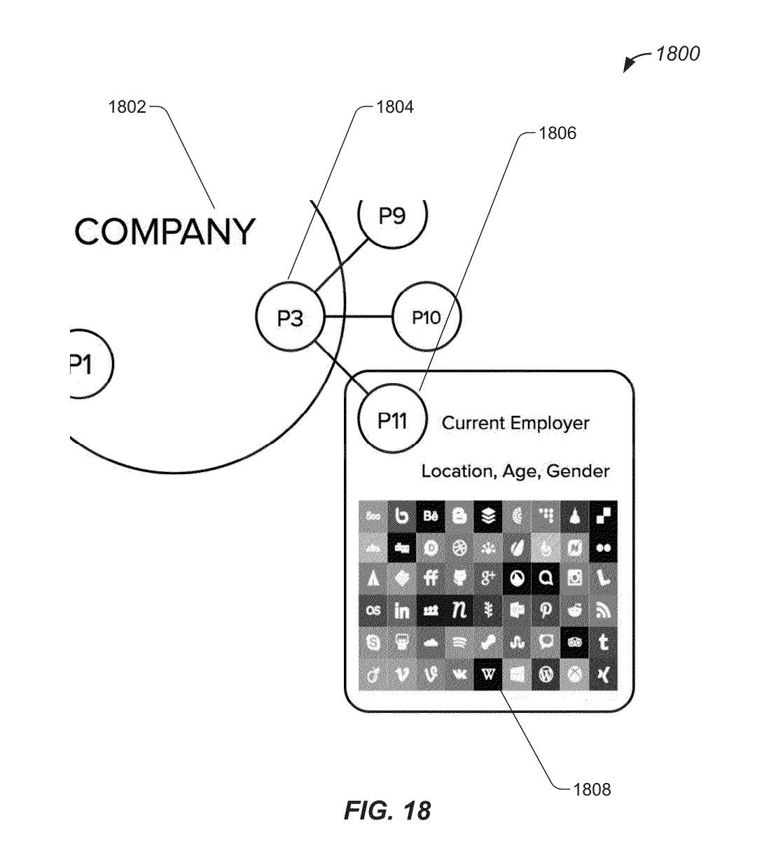

FIG. 18 illustrates a graphical representation of various data sources that may be used to enrich candidate profile data, implemented in accordance with some embodiments. As similarly discussed above, for a recruiter at a company, such as company 1802, to find prospective candidates, such as candidate 1806, connected to employees, such as employee 1804, each candidate may have a profile of information that may be indexed to search. To build or populate the search index of candidate profile data objects, a system component may crawl the web and build candidate profile data objects based on available public sources of information from websites. In various embodiments, the system may collect and store candidate profile data in the index, and then the candidate profile data objects may be combined with retrieved social data. As shown in FIG. 18, candidate profile information, which may include data such as a current employer, geographical location, age, and gender, may be combined with all available public sources of candidate profile data by crawling many sites and indexing matching information. Such sites may include user profiles, such as user profiles 1808, associated with various different social media services. Accordingly, the candidate profile data object associated with candidate 1806 may include a unified and integrated view of candidate 1806 that has been generated based on several disparate data sources.

FIG. 19 illustrates a data processing system configured in accordance with some embodiments. Data processing system 1900, also referred to herein as a computer system, may be used to implement one or more computers or processing devices used in a controller, server, or other components of systems described above, such as a referral processor 106. In some embodiments, data processing system 1900 includes communications framework 1902, which provides communications between processor unit 1904, memory 1906, persistent storage 1908, communications unit 1910, input/output (I/O) unit 1912, and display 1914. In this example, communications framework 1902 may take the form of a bus system.

Processor unit 1904 serves to execute instructions for software that may be loaded into memory 1906. Processor unit 1904 may be a number of processors, as may be included in a multi-processor core. In various embodiments, processor unit 1904 is specifically configured to process large amounts of data that may be involved when processing profile data associated with one or more candidates, as discussed above. Thus, processor unit 1904 may be an application specific processor that may be implemented as one or more application specific integrated circuits (ASICs) within a processing system. Such specific configuration of processor unit 1904 may provide increased efficiency when processing the large amounts of data involved with the previously described systems, devices, and methods. Moreover, in some embodiments, processor unit 1904 may be include one or more reprogrammable logic devices, such as field-programmable gate arrays (FPGAs), that may be programmed or specifically configured to optimally perform the previously described processing operations in the context of large and complex data sets sometimes referred to as “big data.”

Memory 1906 and persistent storage 1908 are examples of storage devices 1916. A storage device is any piece of hardware that is capable of storing information, such as, for example, without limitation, data, program code in functional form, and/or other suitable information either on a temporary basis and/or a permanent basis. Storage devices 1916 may also be referred to as computer readable storage devices in these illustrative examples. Memory 1906, in these examples, may be, for example, a random access memory or any other suitable volatile or non-volatile storage device. Persistent storage 1908 may take various forms, depending on the particular implementation. For example, persistent storage 1908 may contain one or more components or devices. For example, persistent storage 1908 may be a hard drive, a flash memory, a rewritable optical disk, a rewritable magnetic tape, or some combination of the above. The media used by persistent storage 1908 also may be removable. For example, a removable hard drive may be used for persistent storage 1908.

Communications unit 1910, in these illustrative examples, provides for communications with other data processing systems or devices. In these illustrative examples, communications unit 1910 is a network interface card.

Input/output unit 1912 allows for input and output of data with other devices that may be connected to data processing system 1900. For example, input/output unit 1912 may provide a connection for user input through a keyboard, a mouse, and/or some other suitable input device. Further, input/output unit 1912 may send output to a printer. Display 1914 provides a mechanism to display information to a user.

Instructions for the operating system, applications, and/or programs may be located in storage devices 1916, which are in communication with processor unit 1904 through communications framework 1902. The processes of the different embodiments may be performed by processor unit 1904 using computer-implemented instructions, which may be located in a memory, such as memory 1906.

These instructions are referred to as program code, computer usable program code, or computer readable program code that may be read and executed by a processor in processor unit 1904. The program code in the different embodiments may be embodied on different physical or computer readable storage media, such as memory 1906 or persistent storage 1908.

Program code 1918 is located in a functional form on computer readable media 1920 that is selectively removable and may be loaded onto or transferred to data processing system 1900 for execution by processor unit 1904. Program code 1918 and computer readable media 1920 form computer program product 1922 in these illustrative examples. In one example, computer readable media 1920 may be computer readable storage media 1924 or computer readable signal media 1926.

In these illustrative examples, computer readable storage media 1924 is a physical or tangible storage device used to store program code 1918 rather than a medium that propagates or transmits program code 1918.

Alternatively, program code 1918 may be transferred to data processing system 1900 using computer readable signal media 1926. Computer readable signal media 1926 may be, for example, a propagated data signal containing program code 1918. For example, computer readable signal media 1926 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 1900 are not meant to provide architectural limitations to the manner in which different embodiments may be implemented. The different illustrative embodiments may be implemented in a data processing system including components in addition to and/or in place of those illustrated for data processing system 1900. Other components shown in FIG. 19 can be varied from the illustrative examples shown. The different embodiments may be implemented using any hardware device or system capable of running program code 1918.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A method comprising:
retrieving candidate profile data and social connection data from at least one data source, the candidate profile data characterizing one or more features associated with a plurality of candidates, and the social connection data characterizing social connections between the plurality of candidates and a plurality of other entities;
generating a first plurality of candidate profile data objects based on the retrieved candidate profile data and social connection data, each of the first plurality of candidate profile data objects being associated with at least one candidate; and
generating an index data object based on the first plurality of candidate profile data objects.

2. The method of claim 1, wherein the candidate profile data characterizes professional experience and biographical data associated with the plurality of candidates.

3. The method of claim 2, wherein the retrieved data is aggregated from a plurality of heterogeneous data sources comprising a plurality of social networking sites and at least one employee database.

4. The method of claim 3, wherein the generating of the plurality of candidate profile data objects comprises:
merging at least some of the data retrieved from the plurality of heterogeneous data sources into the first plurality of candidate profile data objects.

5. The method of claim 4, wherein the generating of the plurality of candidate profile data objects comprises:
mapping at least some of the data retrieved from the plurality of heterogeneous data sources to a plurality of previously stored candidate profile data objects.

6. The method of claim 1 further comprising:
receiving a plurality of search parameters associated with an employment opportunity.

7. The method of claim 6 further comprising:
querying the index data object based on the plurality of search parameters to identify a second plurality of candidate profile data objects; and
generating a result object based on the identified second plurality of candidate profile data objects.

8. The method of claim 7, wherein the result represents the second plurality of candidates sorted based on their associated connectivity metrics.

9. The method of claim 8, wherein the result enables automatic generating one or more messages specific to at least one candidate associated with the second plurality of candidate profile data objects.

10. The method of claim 9, further comprising:
automatically updating a data storage system based on one or more data values associated with the one or more automatic messages.

11. A system comprising:
a profile data aggregator configured to:
retrieve candidate profile data and social connection data from at least one data source, the candidate profile data characterizing one or more features associated with a plurality of candidates, and the social connection data characterizing social connections between the plurality of candidates and a plurality of other entities;
generate a first plurality of candidate profile data objects based on the retrieved candidate profile data and social connection data, each of the first plurality of candidate profile data objects being associated with at least one candidate;
generate an index data object based on the first plurality of candidate profile data objects;
a connectivity metric generator configured to generate a plurality of connectivity metrics based, at least in part, on the first plurality of candidate profile data objects; and
a referral processing engine configured to return at least one candidate and at least one employee as a result of a search executed on the index data object.

12. The system of claim 11, wherein the retrieved data is aggregated from a plurality of heterogeneous data sources comprising a plurality of social networking sites and at least one employee database, and wherein the profile data aggregator is further configured to:
merge at least some of the data retrieved from the plurality of heterogeneous data sources into the first plurality of candidate profile data objects.

13. The system of claim 12, wherein the generating of the first plurality of candidate profile data objects comprises:
mapping at least some of the data retrieved from the plurality of heterogeneous data sources to a plurality of previously stored candidate profile data objects.

14. The system of claim 11, wherein the referral processing engine is further configured to query the index data object based on a plurality of search parameters to identify a second plurality of candidate profile data objects, and wherein the referral processing engine is further configured to generate a result object based on the identified second plurality of candidate profile data objects.

15. The system of claim 11, wherein the referral processing engine is further configured to generate one or more messages based, at least in part, on the plurality of connectivity metrics, the one or more messages being configured to automate a referral of at least one candidate.

16. A device comprising:
a first processing node configured to:
retrieve candidate profile data and social connection data from at least one data source, the candidate profile data characterizing one or more features associated with a plurality of candidates, and the social connection data characterizing social connections between the plurality of candidates and a plurality of other entities;
generate a first plurality of candidate profile data objects based on the retrieved candidate profile data and social connection data, each of the first plurality of candidate profile data objects being associated with at least one candidate;
generate an index data object based on the first plurality of candidate profile data objects; and
a second processing node configured to generate a plurality of connectivity metrics based, at least in part, on the first plurality of candidate profile data objects; and
a third processing node configured to return at least one candidate and at least one employee as a result of a search executed on the index data object.

17. The device of claim 16, wherein the retrieved data is aggregated from a plurality of heterogeneous data sources comprising a plurality of social networking sites and at least one employee database, and wherein first processing node is further configured to:
merge at least some of the data retrieved from the plurality of heterogeneous data sources into the first plurality of candidate profile data objects.

18. The device of claim 17, wherein the generating of the first plurality of candidate profile data objects comprises:
mapping at least some of the data retrieved from the plurality of heterogeneous data sources to a plurality of previously stored candidate profile data objects.

19. The device of claim 16, wherein the third processing node is further configured to query the index data object based on a plurality of search parameters to identify a second plurality of candidate profile data objects, and wherein the third processing node is further configured to generate a result object based on the identified second plurality of candidate profile data objects.

20. The device of claim 16, wherein the third processing node is further configured to generate one or more messages based, at least in part, on the plurality of connectivity metrics, the one or more messages being configured to automate a referral of at least one candidate.
